(19) United States
(12) Patent Application Publication
(10) Pub. No.: US 2026/0294708 A1
(43) Pub. Date: Oct. 1, 2026

(54) Systems For Providing Power To A Patient Support Apparatus

(71) Applicant: Stryker Corporation, Portage, MI (US)

(72) Inventors: Megan Bair, Portage, MI (US); Kirby M. Neihouser, Francesville, IN (US); Madhu Sandeep Thota, Portage, MI (US); Tyler Ethen, Portage, MI (US); William Dwight Childs, Plainwell, MI (US); Connor Feldpausch St. John, Kalamazoo, MI (US); Matthew Baker, Portage, MI (US); Celso Henrique Farnese Pires Pereira, Portage, MI (US); Krishna Sandeep Bhimavarapu, Kalamazoo, MI (US); Anish Paul, Kalamazoo, MI (US); Jerald A. Trepanier, Augusta, MI (US)

(73) Assignee: Stryker Corporation, Portage, MI (US)

(21) Appl. No.: 19/477,084

(22) PCT Filed: Apr. 19, 2024
(86) PCT No.: PCT/US2024/025384

§ 371 Date: Oct. 20, 2025

Related U.S. Application Data
(60) Provisional application No. 63/460,677, filed on Apr. 20, 2023.

(51) Int. Cl. A61G 7/018; H01R 13/52; H01R 13/62; H01R 13/629; H02J 7/60; H02J 7/70; H02J 105/46

(52) U.S. Cl. CPC A61G 7/018; H01R 13/5224; H01R 13/6205; H01R 13/629; H02J 7/663; H02J 7/70; H01R 2201/12; H02J 2105/46

(57) ABSTRACT

A system for providing power to a patient support apparatus is provided. The system includes a facility power system and a facility interface. The facility interface is disposed in electrical communication with the facility power system and includes an interface connector and a tether. The system also includes a patient support apparatus including a battery and a charging connection system including a charger and an auxiliary charging cable. The charging connection system is selectively operable between a tether state where the interface connector is disposed in electrical communication with the charging connection system and an auxiliary cable state where a plug of the auxiliary charging cable is disposed in electrical communication with the charging connection system and where electrical communication is interrupted between the charging connection system and the interface connector.

### CROSS-REFERENCE TO RELATED APPLICATION(S)

The subject patent application claims priority to and all the benefits of U.S. Provisional Patent Application No. 63/460,677 filed on Apr. 20, 2023, the disclosure of which is hereby incorporated by reference in its entirety.

### BACKGROUND

Conventional patient support apparatuses typically have one or more components that require electrical power. Such components include actuators, such as motors, pumps, and the like, as well as sensors, user interfaces, and control circuitry that oversees the operation of the one or more actuators. For example, modern hospital beds often include one or more user interfaces that allow a caregiver to control the movement of various portions of the bed, as well as to set alerts, and to monitor conditions of the bed (such as whether a patient has exited the bed or not). Rechargeable batteries may be employed for operating powered devices of patient support apparatuses. Here, a charger may be provided on the patient support apparatus to facilitate charging the battery via an electrical tether that is plugged into an AC power outlet, and AC power may also be utilized to operate powered devices. Additional tethers, cables, and the like may also be utilized to facilitate charging of the battery. communication with various external systems, such as nurse call systems, communication interfaces, networks, and the like.

While patient support apparatuses have generally performed well for their intended purpose, there remains a need in the art to ensure that the battery of the patient support apparatus is charged in a safe manner.

### SUMMARY

The present disclosure provides a system for providing power to a patient support apparatus. The system includes a facility power system for providing a source of alternating current power to a plurality of outlets and a facility interface disposed in electrical communication with the source of alternating current power. The facility interface includes a facility module coupled to the source of alternating current power, an interface connector supporting an interface magnetic element and an interface terminal, and a tether extending between the facility module and the interface connector to electrically couple the interface terminal with the source of alternating current power. The system also includes a patient support apparatus. The patient support apparatus includes a support structure with a patient support deck, a battery operatively attached to the support structure, a powered device to perform a powered function of the patient support apparatus, and a charging connection system including a charger disposed in electrical communication with the battery, an apparatus interface disposed in electrical communication with the charger and including an apparatus connector shaped to receive the interface connector and supporting an apparatus magnetic element and an apparatus terminal, and an auxiliary charging cable extending to a plug configured to releasably couple to one of the plurality of outlets. The charging connection system is selectively operable between a tether state where the interface connector is disposed in electrical communication with the charging connection system, and an auxiliary cable state where the plug of the auxiliary charging cable is disposed in electrical communication with the charging connection system and where electrical communication is interrupted between the charging connection system and the interface connector.

The present disclosure also provides a system for providing power to a patient support apparatus. The system includes a facility power system for providing a source of alternating current power to a plurality of outlets; a facility interface disposed in electrical communication with the source of alternating current power and including: a facility module coupled to the source of alternating current power, an interface connector supporting an interface magnetic element, and a tether extending between the facility module and the interface connector to electrically couple with the source of alternating current power; and a patient support apparatus including: a support structure with a patient support deck, a battery operatively attached to the support structure, a powered device to perform a powered function of the patient support apparatus, a charging connection system including: a charger disposed in electrical communication with the battery; an apparatus interface disposed in electrical communication with the charger and including an apparatus connector shaped to receive the interface connector and supporting an apparatus magnetic element; and an auxiliary charging cable extending to a plug configured to releasably couple to one of the plurality of outlets; where the charging connection system is selectively operable between: a tether state where the interface connector is disposed in electrical communication with the charging connection system via connection to the apparatus connector and where electrical communication is interrupted between the charging connection system and the plug of the auxiliary charging cable, and an auxiliary cable state where the plug of the auxiliary charging cable is disposed in electrical communication with the charging connection system and where electrical communication is interrupted between the charging connection system and the apparatus connector.

### BRIEF DESCRIPTION OF THE DRAWINGS

Advantages of the present invention will be readily appreciated as the same becomes better understood by reference to the following detailed description when considered in connection with the accompanying drawings.

FIG. 1 is perspective view of a patient support apparatus having a base, a litter with a patient support deck, a lift mechanism, side rails, a charging connection system, and an apparatus interface shown positioned adjacent to a facility interface coupled to a facility power system.

FIG. 2 is an illustrative view of a control system of the patient support apparatus of FIG. 1.

FIG. 3A is a schematic right-side view of the patient support apparatus of FIG. 1, shown with each of the side rails arranged in a raised position.

FIG. 3B is another schematic right-side view of the patient support apparatus of FIG. 3A, shown with a first side rail arranged in an intermediate position, and shown with a second side rail arranged in the raised position.

FIG. 3C is another schematic right-side view of the patient support apparatus of FIGS. 3A-3B, shown with the first side rail arranged in a lowered position.

FIG. 4A is another schematic right-side view of the patient support apparatus of FIGS. 3A-3C, shown with two of the side rails removed for illustrative purpose, and with the lift mechanism supporting the litter in a raised configuration.

FIG. 4B is another schematic right-side view of the patient support apparatus of FIG. 4A, shown with the lift mechanism supporting the litter in a lowered configuration.

FIG. 5 is another schematic right-side view of the patient support apparatus of FIG. 4B, shown with the patient support deck having a back section arranged in a fowler's position with the second side rail coupled to the back section.

FIG. 6 is another schematic right-side view of the patient support apparatus of FIG. 5, shown with the lift mechanism supporting the litter in an inclined configuration.

FIG. 7 is a perspective view of the apparatus interface and the facility interface of FIG. 1.

FIG. 8 is another perspective view of the apparatus interface and the facility interface of FIG. 7, shown with the apparatus connector spaced from and disposed in keyed alignment with the facility interface along an axis.

FIG. 9 is an exploded perspective view of the apparatus interface and the facility interface of FIG. 8, the apparatus interface shown including an apparatus connector with an apparatus terminal, and the facility interface shown including an interface connector having a face and an interface terminal.

FIG. 10 is another exploded perspective view of the apparatus interface and the facility interface of FIG. 9.

FIG. 11 is an enlarged plan view of the apparatus interface and the facility interface of FIGS. 8-10 taken facing towards a back side of the apparatus interface arranged spaced from and in keyed alignment with the facility interface.

FIG. 12A is sectional view of the facility interface and the apparatus interface taken along line 12-12 of FIG. 11, shown with the facility interface spaced from the apparatus interface, and with the interface connector arranged spaced from the apparatus connector.

FIG. 12B is another sectional view of the facility interface and the apparatus interface of FIG. 12A, shown with the facility interface having moved into initial engagement with the apparatus interface but with the interface terminal of the interface connector still spaced from the apparatus terminal of the apparatus connector.

FIG. 12C is another sectional view of the facility interface and the apparatus interface of FIGS. 12A and 12B, shown with the facility interface releasably coupled to the apparatus interface in a connected state, and shown with the interface terminal in abutment with the apparatus terminal.

FIG. 13A is a schematic view of a first instance of the charging connection system of the patient support apparatus of FIG. 1, wherein the charging connection system operates in a disconnected state.

FIG. 13B is another schematic view of the first instance of the charging connection system shown in FIG. 13A, wherein the charging connection system operates in an auxiliary cable state and a connected state.

FIG. 13C is another schematic view of a first instance of the charging connection system shown in FIG. 13A, wherein the charging connection system operates in a tether state and a connected state.

FIG. 14A is a schematic view of a second instance of the charging connection system of the patient support apparatus of FIG. 1, wherein the charging connection system operates in a disconnected state.

FIG. 14B is another schematic view of the second instance of the charging connection system shown in FIG. 14A, wherein the charging connection system operates in a tether state and a connected state.

FIG. 14C is another schematic view of the second instance of the charging connection system shown in FIG. 14A, wherein the charging connection system operates in an auxiliary cable state and a connected state.

FIG. 15A is a schematic view of a third instance of the charging connection system of the patient support apparatus of FIG. 1, wherein the charging connection system operates in a disconnected state.

FIG. 15B is another schematic view of the third instance of the charging connection system shown in FIG. 15A, wherein the charging connection system operates in a tether state and a connected state.

FIG. 15C is another schematic view of the third instance of the charging connection system shown in FIG. 15A, wherein the charging connection system operates in an auxiliary cable state and a connected state.

FIG. 16A is a schematic view of a fourth instance of the charging connection system of the patient support apparatus of FIG. 1, wherein the charging connection system includes a selector, and wherein the charging connection system operates in a disconnected state and the selector is in a first blocking position.

FIG. 16B is a schematic view of the fourth instance of the charging connection system shown in FIG. 16A, wherein the charging connection system operates in a disconnected state and the selector is in a second blocking position.

FIG. 16C is a schematic view of the fourth instance of the charging connection system shown in FIG. 16A, wherein the charging connection system operates in a tethered state and a connected state and the selector is in the first blocking position.

FIG. 16D is a schematic view of the fourth instance of the charging connection system shown in FIG. 16A, wherein the charging connection system operates in an auxiliary cable state and a connected state and the selector is in the second blocking position.

FIG. 17A is a schematic view of a fifth instance of the charging connection system of the patient support apparatus of FIG. 1, wherein the charging connection system operates in a disconnected state.

FIG. 17B is another schematic view of the fifth instance of the charging connection system shown in FIG. 17A, wherein the charging connection system operates in a tether state and a connected state.

FIG. 17C is another schematic view of the fifth instance of the charging connection system shown in FIG. 17A, wherein the charging connection system operates in an auxiliary cable state and a connected state.

FIG. 18A is a perspective view depicting an instance of an apparatus socket and a plug shown in a disconnected state.

FIG. 18B is another perspective view of the apparatus socket and the plug of FIG. 18A shown in a connected state.

FIG. 19A is a perspective view depicting another instance of an apparatus socket and a plug shown in a disconnected state.

FIG. 19B is another perspective view of the apparatus socket and the plug of FIG. 19A shown in a connected state.

FIG. 20A is a perspective view depicting another instance of an apparatus socket and a plug shown in a disconnected state.

FIG. 20B is another perspective view of the apparatus socket and the plug of FIG. 20A shown in a connected state.

FIG. 21A is a perspective view depicting another instance of an apparatus socket and a plug shown in a disconnected state.

FIG. 21B is another perspective view of the apparatus socket and the plug of FIG. 21A shown in a connected state.

FIG. 22A is a perspective view depicting another instance of an apparatus socket and a plug shown in a disconnected state.

FIG. 22B is another perspective view of the apparatus socket and the plug of FIG. 22A shown in a connected state.

FIG. 23A is a perspective view depicting another instance of an apparatus socket and a plug shown in a disconnected state.

FIG. 23B is another perspective view of the apparatus socket and the plug of FIG. 23A shown in a connected state, with a bolt latch shown spaced from the apparatus socket.

FIG. 23C is another is another perspective view of the apparatus socket and the plug of FIG. 23B shown in the connected state, with the bolt latch shown seated in the apparatus socket.

FIG. 23D is another is another perspective view of the apparatus socket and the plug of FIG. 23C shown in the connected state, with the bolt latch shown secured to the apparatus socket.

FIG. 24A is a perspective view depicting another instance of an apparatus socket and a plug shown in a disconnected state, and with a lock ring shown in a first ring position.

FIG. 24B is another perspective view of the apparatus socket and the plug of FIG. 24B shown in the disconnected state, and with the lock ring shown in a second ring position.

FIG. 24C is another is another perspective view of the apparatus socket and the plug of FIG. 24B shown in an intermediate state, and with the lock ring shown in the second ring position.

FIG. 24D is another is another perspective view of the apparatus socket and the plug of FIG. 24C shown in a connected state, and with the lock ring shown in the first ring position.

### DETAILED DESCRIPTION

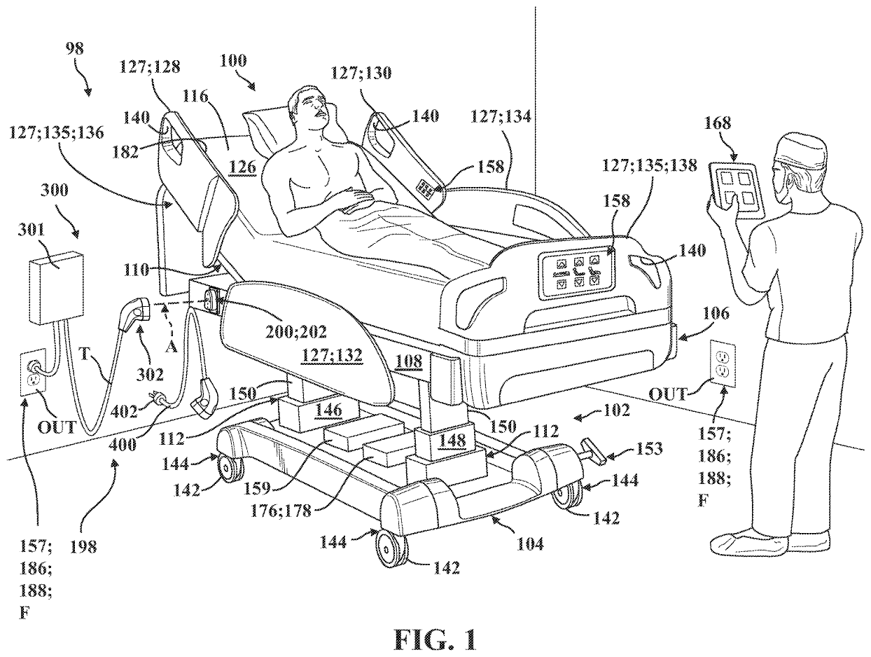

Referring to the drawings, wherein like numerals indicate like or corresponding parts throughout the several views, a patient support system 98 including a patient support apparatus 100 and portions of a facility power system F is shown in FIG. 1. The patient support apparatus 100 supports a patient in a heath care setting, such as within a facility realized as a hospital or another setting for treating patients. The facility power system F may be realized as a power system within such a facility, such as a power system of a hospital or a power system of another setting for treating patients. The patient support apparatus 100 illustrated throughout the drawings is realized as a hospital bed. In other versions, however, the patient support apparatus 100 may be a stretcher, a cot, a table, a wheelchair, a chair, or a similar apparatus utilized in the care of a patient.

The patient support apparatus 100 includes a support structure 102 which provides support for the patient. In the representative version illustrated herein, the support structure 102 generally comprises a base 104 and a litter 106. Here, the litter 106 includes an intermediate frame 108 and a patient support deck 110 spaced above the base 104. As is described in greater detail below, a lift mechanism 112 is interposed between the base 104 and the intermediate frame 108 to facilitate moving the litter 106 relative to the base 104 between a plurality of vertical configurations/poses, including without limitation one or more raised configurations, lowered configurations, and/or inclined configurations such as a Trendelenburg configuration.

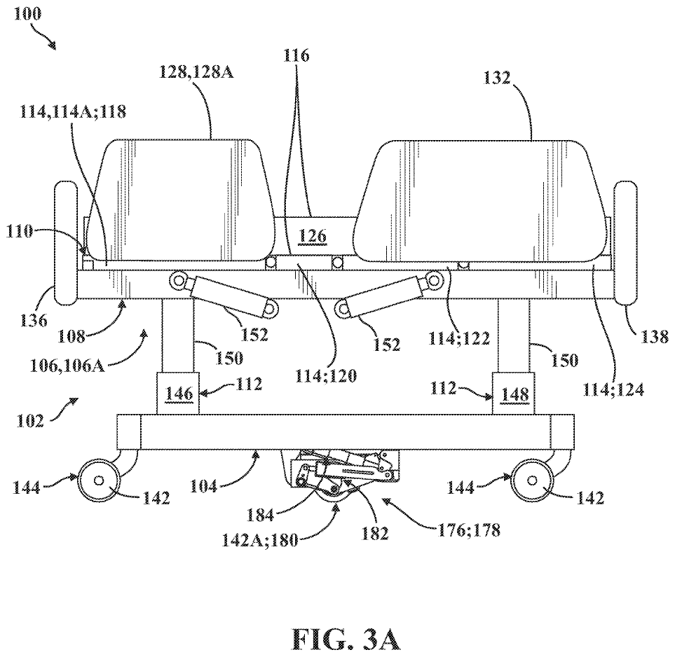

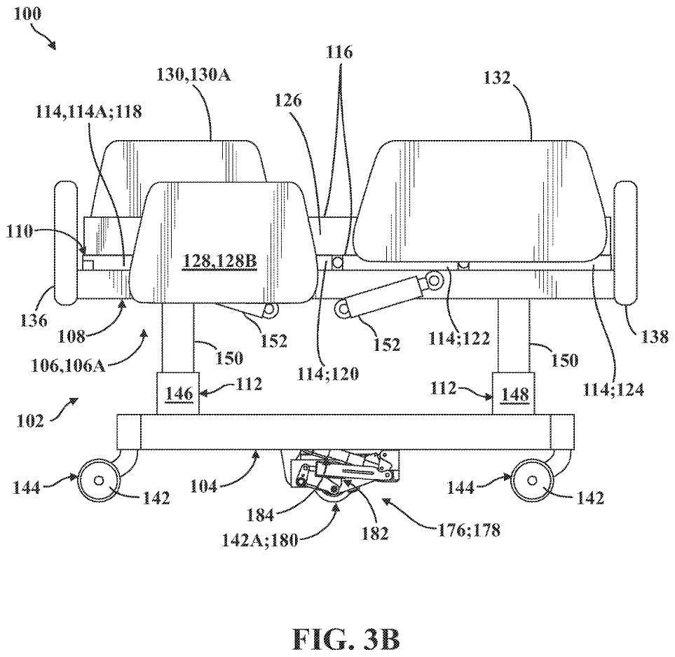

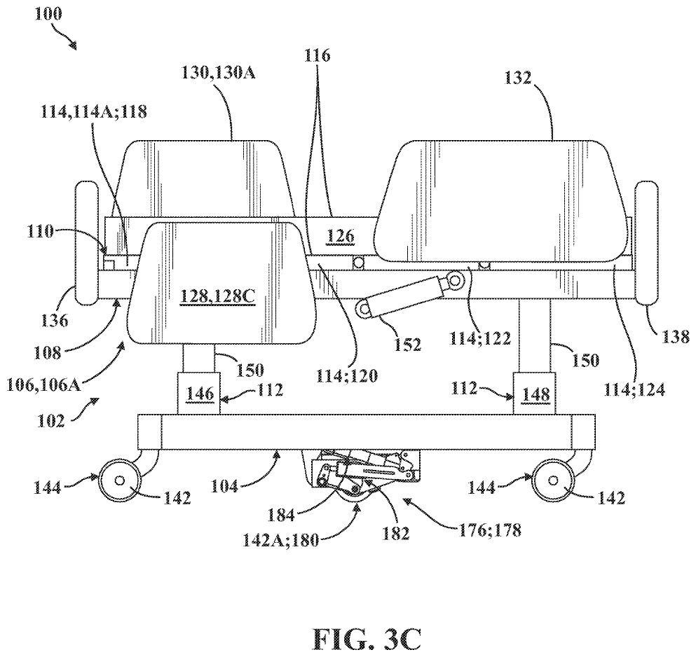

The patient support deck 110 has at least one deck section 114 arranged for movement relative to the intermediate frame 108 between a plurality of section positions 114A, 114B. The deck sections 114 of the patient support deck 110 provide a patient support surface 116 upon which the patient is supported. More specifically, in the representative version of the patient support apparatus 100 illustrated herein, the patient support deck 110 has four deck sections 114 which cooperate to define the patient support surface 116: a back section 118, a seat section 120, a leg section 122, and a foot section 124 (see FIGS. 3A-6). In the representative version illustrated herein, the seat section 120 is fixed to the intermediate frame 108 and is not arranged for movement relative thereto. However, it will be appreciated that the seat section 120 could be movable relative to other deck sections 114 in some versions. Conversely, the back section 118 and the leg section 122 are arranged for independent movement relative to each other and to the intermediate frame 108, as described in greater detail below, and the foot section 124 is arranged to move partially concurrently with the leg section 122.

Other configurations are contemplated, and it will be appreciated that different arrangements of deck sections 114 are contemplated by the present disclosure. By way of non-limiting example, the patient support deck 110 could be configured without a discrete seat section 120 in some versions. Furthermore, while the representative version of the litter 106 illustrated herein employs the intermediate frame 108 to support the deck sections 114 of the patient support deck 110 for movement relative to the base 104 via the lift mechanism 112, it will be appreciated that various types of litters 106, with or without discrete intermediate frames 108 and/or with a differently-configured lift mechanism 112, are contemplated by the present disclosure. In some versions, the patient support deck 110 and its associated deck sections 114 may be similar to as is described in U.S. Pat. No. 11,116,680, entitled “Patient Support Apparatus for Controlling Patient Ingress and Egress,” the disclosure of which is hereby incorporated by reference in its entirety.

A mattress 126 may be disposed on the patient support deck 110 during use. The mattress 126 comprises or otherwise defines the patient support surface 116 upon which the patient is supported, but it will be appreciated that its shape is defined based on the arrangement of the patient support deck 110. Here too, it will be appreciated that the patient support deck 110 itself would define the patient support surface 116 during operation of some versions of the patient support apparatus 100 without the mattress 126. Put differently, the mattress 126 may be omitted in certain versions, such that the patient can rest directly on the patient support surface 116 defined by the deck sections 114 of the patient support deck 110. The base 104, the litter 106, the intermediate frame 108, and the patient support deck 110 each have a head end and a foot end corresponding to designated placement of the patient's head and feet on the patient support apparatus 100. It will be appreciated that the specific configuration of the support structure 102 may take on any known or conventional design and is not limited to that specifically illustrated and described herein. Other configurations are contemplated.

Side rails 128, 130, 132, 134 are coupled to the support structure 102 via mounts and are supported for movement relative to the intermediate frame 108 (and, thus, relative to the base 104). A first side rail 128 is positioned at a right head end of the litter 106. A second side rail 130 is positioned at a left head end of litter 106. A third side rail 132 is positioned at a right foot end of the litter 106. A fourth side rail 134 is positioned at a left foot end of the litter 106. One or more of the side rails may be coupled to one or mounts via linkages and may be movable between a plurality of side rail positions, including a raised position, in which they block ingress and egress into and out of the patient support apparatus 100, one or more intermediate positions, and a lowered position in which they are not an obstacle to such ingress and egress across the periphery of the patient support surface 116. It will be appreciated that there may be fewer side rails for certain versions, such as where the patient support apparatus 100 is realized as a stretcher or a cot. Similarly, it will be appreciated that side rails may be attached to any suitable component or structure of the patient support apparatus 100, and that their respective mount and/or linkage may be configured in various ways. In some versions, the side rails 128, 130, 132, 134 or other portions of the patient support apparatus 100 may be similar to as is described in U.S. Patent Application Publication No. US 2021/0338504 A1, entitled “Side Rail Assembly For A Patient Support Apparatus,” the disclosure of which is hereby incorporated by reference in its entirety. Other configurations are contemplated. In the representative version illustrated herein, the first and second side rails 128, 130 are coupled to the back section 118 of the patient support deck 110 and move concurrently therewith.

As shown in FIG. 1, a headboard 136 and a footboard 138 are coupled to respective mounts of the intermediate frame 108 of the litter 106. However, it will be appreciated that the headboard 136 and/or footboard 138 may be coupled to other locations on the patient support apparatus 100, such as the base 104, or may be omitted in certain versions. One or more caregiver interfaces 140, such as handles, are shown in FIG. 1 as being integrated into the first and second side rails 128, 130 to facilitate movement of the patient support apparatus 100 over floor surfaces. Additional caregiver interfaces 140 may be integrated into the headboard 136, the footboard 138, and/or other components of the patient support apparatus 100, such as the third and/or fourth side rails 132, 134, the intermediate frame 108, and the like. The caregiver interfaces 140 are shaped so as to be grasped by a caregiver as a way to position or otherwise manipulate the patient support apparatus 100 for movement. It will be appreciated that the caregiver interfaces 140 could be integrated with or operatively attached to any suitable portion of the patient support apparatus 100 or may be omitted in certain versions.

Wheels 142 are coupled to the base 104 to facilitate transportation over floor surfaces. The wheels 142 are arranged in each of four quadrants of the base 104, adjacent to corners of the base 104. In the version shown in FIG. 1, the wheels 142 are caster wheels that are able to rotate and swivel relative to the support structure 102 during transport. Here, each of the wheels 142 forms part of a caster assembly 144 mounted to the base 104. In the illustrated version, the patient support apparatus 100 includes a brake assembly 153 operatively attached to one or more of the wheels 142 and being operable between a braked state to inhibit movement of the base 104 about floor surfaces, and an unbraked state to permit movement of the base 104 about floor surfaces. In some versions, the wheels 142 and brake assembly 153 may be similar to as is disclosed in U.S. Pat. No. 10,806,653, entitled “Patient Transport Apparatus With Electro-Mechanical Braking System,” and/or International Patent Application Publication No. WO 2021/138176 A1, entitled “Patient Transport Apparatus With Electro-Mechanical Braking System,” the disclosures of each of which are hereby incorporated by reference in their entirety. Other configurations are contemplated.

It should be understood that various configurations of the caster assemblies 144 are contemplated. In addition, in some versions, the wheels 142 are not caster wheels. Moreover, it will be appreciated that the wheels 142 may be non-steerable, steerable, non-powered, powered, or combinations thereof. While the representative version of the patient support apparatus 100 illustrated herein employs four wheels 142, additional wheels are also contemplated. For example, the patient support apparatus 100 may comprise four non-powered, non-steerable wheels, along with one or more additional powered wheels. In some cases, the patient support apparatus may not include any wheels. In other versions, one or more auxiliary wheels (powered or non-powered), which are movable between stowed positions and deployed positions, may be coupled to the support structure 102. In some cases, when auxiliary wheels are located between caster assemblies 144 and contact the floor surface in the deployed position, they cause two of the caster assemblies 144 to be lifted off the floor surface, thereby shortening a wheel base of the patient support apparatus 100. A fifth wheel may also be arranged substantially in a center of the base 104.

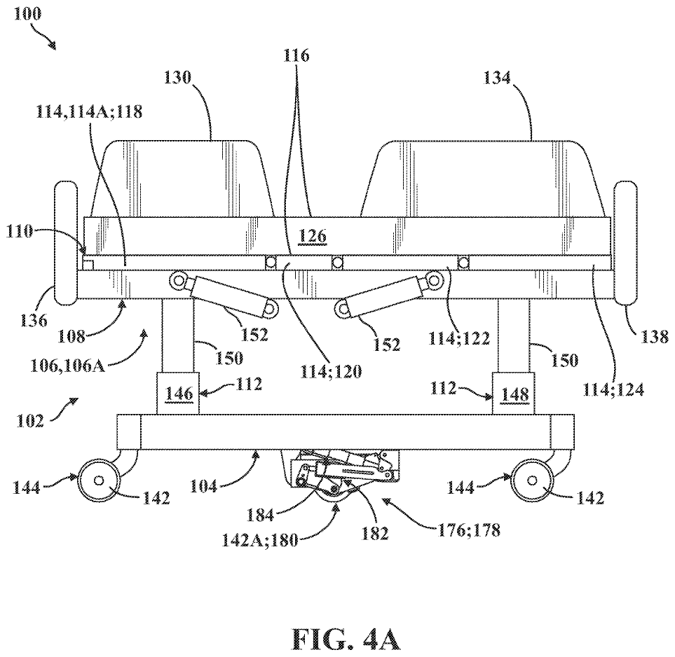

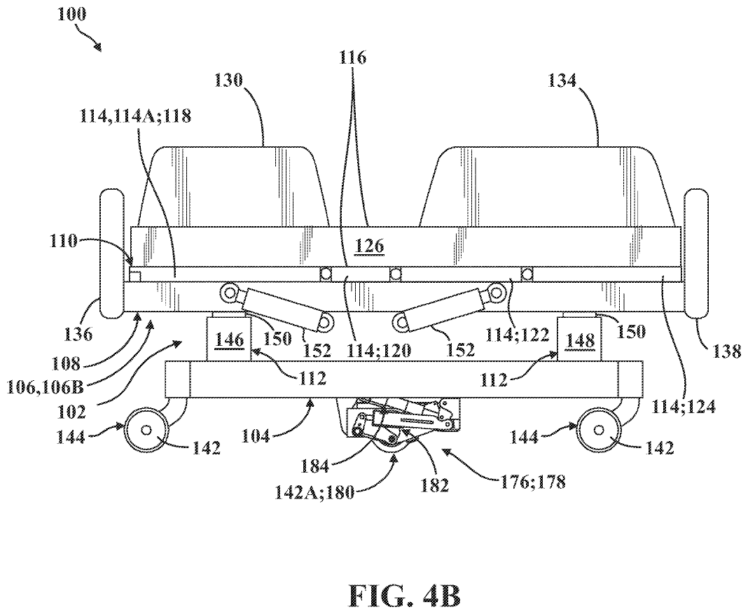

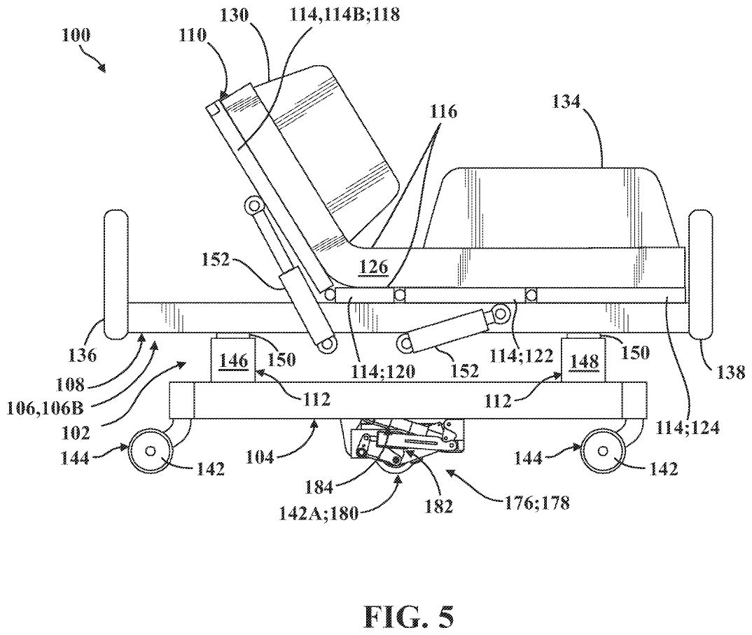

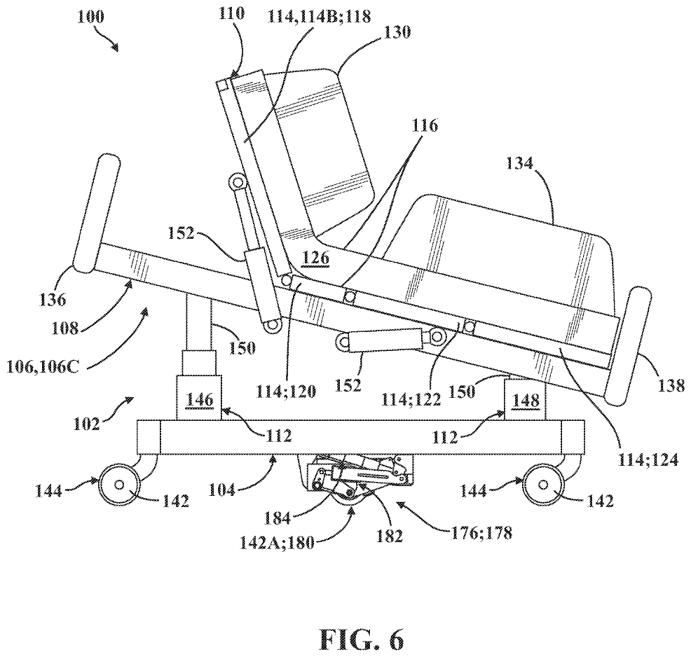

As noted above, the patient support apparatus 100 employs the lift mechanism 112 to lift and lower the litter 106 relative to the base 104 which, in turn, moves the intermediate frame 108 together with the patient support deck 110 between various vertical configurations, such as to the raised vertical configuration 106A depicted in FIGS. 3A-4A, the lowered vertical configuration 106B depicted in FIGS. 4B-5, or to any desired vertical configuration therebetween including various inclined configurations 106A such as is depicted in FIG. 6. To this end, the lift mechanism 112 may include a head end lift member 146 and a foot end lift member 148 which are each arranged to facilitate movement of the litter 106 with respect to the base 104 using one or more lift actuators 150. The lift actuators 150 may be realized as linear actuators, rotary actuators, or other types of actuators, and may be electrically operated and/or may be hydraulic. It is contemplated that, in some configurations, only one lift member and one associated lift actuator may be employed, e.g., to raise only one end of the litter 106 (see FIG. 6), or one central lift actuator to raise and lower the litter 106. The construction of the lift mechanism 112, the head end lift member 146, and/or the foot end lift member 148 may take on any known or conventional design, and is not limited to that specifically illustrated. By way of non-limiting example, the lift mechanism 112 could comprise a “scissor” linkage arranged between the base 104 and the litter 106 with one or more actuators configured to facilitate vertical movement of the patient support deck 110. In some versions, the lift mechanism 112 may be similar to as is described in U.S. Pat. No. 10,172,753, entitled “Patient Support Lift Assembly,” the disclosure of which is hereby incorporated by reference in its entirety. Other configurations are contemplated.

As noted above, the patient support deck 110 is operatively attached to the intermediate frame 108 (e.g., as depicted in FIGS. 1 and 3A-6), with one or more of the deck sections 114 arranged for movement between a first section position 114A (see FIGS. 3A-4B) and a second section position 114B (see FIGS. 5-6). To this end, one or more deck actuators 152 are interposed between the deck section 114 and the intermediate frame 108 to move the deck section 114. In the representative versions illustrated herein, the deck actuator 152 is realized as a linear actuator disposed in force-translating relationship between the deck section 114 and the intermediate frame 108. More specifically, one deck actuator 152 is provided between the intermediate frame 108 and the back section 118, and another deck actuator 152 is provided between the intermediate frame 108 and the leg section 122, and each of the deck actuators 152 is arranged for independent movement to position the respective deck sections 114 to adjust the shape of the patient support surface 116 between a plurality of patient support configurations (for example, a flat configuration, a raised fowler configuration, a seated configuration, etc.). Here, the deck actuator 152 coupled to the back section 118 is configured to move the back section 118 between the first section position 114A (see FIGS. 3A-4B), the second section position 114B (see FIGS. 5-6), as well as to additional section positions between the first and second section positions 114A, 114B and/or to section positions beyond the second section position 114B.

Those having ordinary skill in the art will appreciate that the patient support apparatus 100 could employ any suitable number of deck actuators 152, of any suitable type or configuration sufficient to effect selective movement of one or more of the deck sections 114 relative to the litter 106 or other components of the support structure 102. By way of non-limiting example, the deck actuator 152 could be a linear actuator or one or more rotary actuators driven electronically and/or hydraulically, and/or controlled or driven in any suitable way. Moreover, the deck actuator 152 could be mounted, secured, coupled, or otherwise operatively attached to the intermediate frame 108 and to the deck section 114, either directly or indirectly, in any suitable way. In addition, one or more of the deck actuators 152 could be omitted for certain applications.

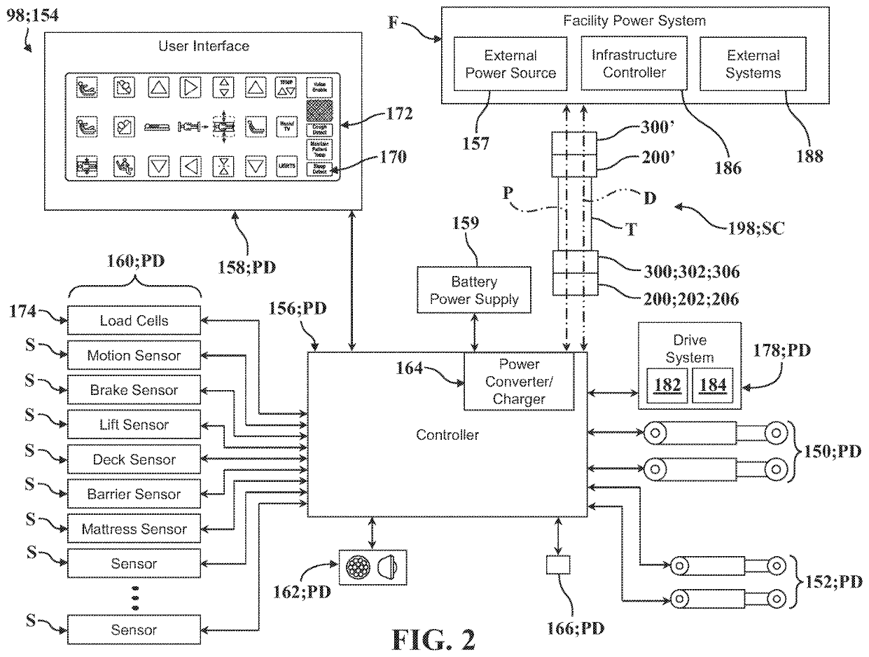

Referring to FIG. 2, the patient support apparatus 100 employs a control system, generally indicated at 154, to effect operation of various functions of the patient support apparatus 100 by powering, driving, communicating with, or otherwise controlling various types of powered devices PD, as described in greater detail below. To this end, and as is shown schematically in FIG. 2, the control system 154 generally includes an apparatus controller 156 disposed in communication with one or more user interfaces 158 adapted for use by the patient and/or the caregiver to facilitate operation of one or more functions of the patient support apparatus 100. The apparatus controller 156 may also be directly or indirectly disposed in communication with powered devices PD, including without limitation the lift actuators 150, the deck actuators 152, one or more sensors S of a sensor system 160, a communication interface 162 for communicating with various remote devices (e.g., smartphones, external systems, and the like), one or more power converters 164, a drive system 178, and/or one or more additional powered devices 166 such as devices to adjust the length and/or width of the litter 106, devices to turn the patient, devices to facilitate ingress and/or egress, devices to facilitate actuation of electric brakes, devices to monitor patient movement and/or bed exit, and the like. Other configurations are contemplated.

In the representative version illustrated in FIGS. 1 and 2, the patient support apparatus 100 comprises a plurality of user interfaces 158 which may be accessible by the patient, the caregiver, or by both the caregiver and the patient. Each user interface 158 of the patient support apparatus 100 generally comprises an input device 170 configured to generate an input signal in response to activation by a user which, in turn, is communicated to the apparatus controller 156. The apparatus controller 156, in turn, is responsive to the input signal and can control or otherwise carry out one or more functions of the patient support apparatus 100 in response to receiving the input signal. Put differently, the apparatus controller 156 is configured to perform a function of the patient support apparatus 100 in response to receiving the input from the input device 170. By way of non-limiting example, the input device 170 could be realized as a “lift bed” button, activation of which causes the apparatus controller 156 to drive the lift actuators 150 to move the intermediate frame 108 of the litter 106 from the maximum lowered configuration vertically away from the base 104 towards the raised configuration.

In some versions, one or more of the user interfaces 158 may also employ an output device 172, such as a screen, one or more audible and/or visual indicators (e.g., speakers, beepers, light emitting diodes LEDs, and the like), to communicate information to the user (e.g., to the caregiver). In some versions, the user interface 158 may be realized as a touchscreen interface that serves as both the input device 170 and the output device 172. In some versions, the apparatus controller 156 may be configured to facilitate navigation of visual content of the user interface 158 (e.g., realized as a graphical user interface GUI) in response to receiving the input signal from the input device 170. Thus, it will be appreciated that the user interface 158 could be configured in a number of different ways sufficient to generate the input signal. Moreover, it will be appreciated that the user interfaces 158 could be of a number of different styles, shapes, configurations, and the like. By way of non-limiting example, one or more of the user interfaces 158 may comprise buttons, indicators, screens, graphical user interfaces, and the like. Other configurations are contemplated.

In some versions, one or more portions of the sensor system 160 may be coupled to the support structure 102 to generate data representing load acting on the support structure 102. To this end, as is depicted schematically in FIG. 2, the sensor system 160 may include a plurality of load cells 174 interposed in force-translating relation between the intermediate frame 108 and the base 104 to measure load acting on the support structure 102 (not shown in detail). Here, each load cell 174 generates a respective output signal representing the amount of weight sensed thereby. In some versions, a total of four load cells 174 are interposed between the intermediate frame 108 and the lift members 146, 148 of the lift mechanism 112 to measure load (e.g., patient weight) acting about the patient support surface 116 as well as on other portions of the intermediate frame 108 or components coupled thereto. It will be appreciated that other arrangements of load cells 174 are contemplated by the present disclosure, and different quantities of load cells 174 arranged in various ways may be employed by the sensor system 160. By way of non-limiting example, load cells could be interposed between the base 104 and the lift mechanism 112 (not shown). In some versions, aspects of the patient support apparatus 100, including the arrangement of load cells 174 about support structures 102, may be similar to as is described in International Patent Application Publication No. WO 2021/242946 A1, entitled “Lift Systems And Load Cells For Patient Support Apparatus;” International Patent Application Publication No. WO 2021/108377, entitled “Patient Support Apparatus With Load Cell Assemblies;” and/or U.S. Patent Application Publication No. US 2021/0030611 A1, entitled “Patient Support Apparatus With Load Cell Assemblies;” the disclosures of each of which are hereby incorporated by reference in their entirety. Other configurations are contemplated.

In some versions, the sensor system 160 may include one or more different types of sensors S for determining changes in the position, state, or operation of various portions of the patient support apparatus 100, and or changes in patient position, status, condition, and the like. In some versions, the patient support apparatus 100 may include one or more sensors S disposed in communication with the apparatus controller 156 to: determine motion of the patient support apparatus 100, to determine operation of the brake assembly 153 (e.g., between braked and unbraked states), to determine an arrangement of the intermediate frame 108 relative to the base 104, to determine movement of one or more deck sections 114, to determine movement of the side rails 128, 130, 132, 134 and/or the headboard 136 or the footboard 138, to determine movement of the mattress 126, and/or to determine changes in the position or status of the patient. It will be appreciated that various sensors S of a number of different types, styles, and/or configurations may be employed, including without limitation limit switches, touch sensors, potentiometers, encoders, pressure sensors, temperature sensors, humidity sensors, optical sensors (e.g., cameras), or other type of sensors responsive to changes in position, contact, orientation, state, and the like. In some versions, the functionality afforded by sensors S could be realized as code operated by the apparatus controller 156 or other portions of the patient support system 98. Other configurations are contemplated.

Referring to FIGS. 3A-6, in some versions, the patient support apparatus 100 includes an auxiliary wheel assembly 176 coupled to the base 104. The auxiliary wheel assembly 176 forms part of a drive system 178 configured to influence motion of the patient support apparatus 100 during transportation over floor surfaces. To this end, the drive system 178 generally includes a drive member 180 and a motor 182 coupled to the drive member 180 to operate the drive member 180 at various speeds. In the illustrated versions, the drive member 180 is realized as an auxiliary wheel 142A. However, those having ordinary skill in the art will appreciate that the drive system 178 could be configured in other ways, with various types of drive members 180 other than those configured as auxiliary wheels 142A of auxiliary wheel assemblies 176. By way of non-limiting example, the drive member 180 could be realized by various types and/or arrangements of one or more belts, treads, wheels, tires, and the like, which may be arranged in various ways about the patient support apparatus 100 and may be deployable, retractable, or similarly movable, or may be generally engaged with the floor surface (e.g., realized as powered wheels at one or more corners of the base 104). Other configurations are contemplated. Accordingly, it will be appreciated that the auxiliary wheel drive system 178 described and illustrated herein represents one type of drive system 178 contemplated by the present disclosure, and the auxiliary wheel 142A described and illustrated herein represents one type of drive member 180 contemplated by the present disclosure.

The auxiliary wheel assembly 176 employs an auxiliary wheel actuator 184 operatively coupled to the auxiliary wheel 142A and operable to move the auxiliary wheel 142A between one or more deployed positions engaging the floor surface, and one or more retracted positions spaced away from and out of contact with the floor surface. The auxiliary wheel 142A influences motion of the patient support apparatus 100 during transportation over the floor surface when the auxiliary wheel 142A is in a deployed position. In some versions, the auxiliary wheel assembly 176 comprises an additional auxiliary wheel movable with the auxiliary wheel via the auxiliary wheel actuator 184. It will be appreciated that operation of the drive system 178 may be effected in various ways, including such as based on signals from the sensor system 160, one or more sensors S, and/or one or more user interfaces 158. In some versions, aspects of the drive system 178 may be similar to as is disclosed in one or more of: U.S. patent application Ser. No. 16/690,217, filed on Nov. 21, 2019, entitled, “Patient Transport Apparatus With Controlled Auxiliary Wheel Deployment;” U.S. patent application Ser. No. 17/131,947, filed on Dec. 23, 2020, entitled, “Patient Transport Apparatus With Controlled Auxiliary Wheel Speed;” and/or U.S. patent application Ser. No. 17/132,009, filed on Dec. 23, 2020, entitled, “Patient Transport Apparatus With Auxiliary Wheel Control Systems;” the disclosures of each of which are hereby incorporated by reference in their entirety. Other configurations are contemplated.

As noted above, the apparatus controller 156 is depicted schematically in FIG. 2 and has been omitted from certain drawings for the purposes of clarity and consistency. It will be appreciated that the apparatus controller 156 and/or the control system 154 can be configured or otherwise arranged in a number of different ways to facilitate operation of the patient support apparatus 100. The apparatus controller 156 may have one or more microprocessors for processing instructions or for processing an algorithm stored in memory to control operation of powered devices PD, generation or interpretation of signals and/or data (e.g., data from sensors S, the sensor system 160, and the like), communication with the user interfaces 158 and/or remote devices (e.g., portable electronic devices), performance of one or more functions of the powered devices PD, and the like. Additionally or alternatively, the apparatus controller 156 may comprise one or more microcontrollers, field programmable gate arrays, systems on a chip, discrete circuitry, and/or other suitable hardware, software, or firmware that is capable of carrying out the various functions and operations described herein. The apparatus controller 156 may be carried on-board the patient support apparatus 100, such as on the base 104 or the litter 106, or may be remotely located. The apparatus controller 156 may comprise one or more sub-controllers configured to control powered devices PD or one or more sub-controllers for each powered device PD. The apparatus controller 156 and/or other parts of the control system 154 may communicate with the powered devices PD (e.g., the actuators 150, 152, the user interfaces 158, and the like) via wired and/or wireless communication.

As will be appreciated from the subsequent description below, power used to operate the powered devices PD, as well as the apparatus controller 156 itself, can be provided by an external power source 157 and/or by a battery 159 operatively coupled to the support structure 102. To this end, the patient support system 98 employs a charging connection system 198 defined by an apparatus interface 200 and a facility interface 300. The apparatus interface 200 is coupled to the patient support apparatus 100, and the facility interface 300 is coupled to or is otherwise formed as a part of the facility power system F. As is described in greater detail below, the apparatus interface 200 and the facility interface 300 are configured for releasable engagement together in a connected state SC to facilitate wired electrical communication of power P and/or data D between the patient support apparatus 100 and the facility power system F. Here, the apparatus interface 200 is disposed in electrical communication with various components of the control system 154, including for example the apparatus controller 156 (and/or various powered devices PD or other components in communication with the apparatus controller 156), the battery 159, and/or a power converter/charger 164; and the facility interface 300 is disposed in electrical communication with various components of the facility power system F, including for example the external power source 157, an infrastructure controller 186, and/or other types of external systems 188 (e.g., nurse call systems, servers, networks, communication systems, and the like). Each of the components of the charging connection system 198 introduced above will be described in greater detail below.

With reference to FIGS. 1 and 2, the facility power system F may be a power system of a hospital or a power system of another area for facilitating patient care. The facility power system F provides or otherwise defines the external power source 157, which may be realized such as by an Alternating Current power source (e.g., 110-220 VAC at 50-60 Hz) that is supplied to the facility power system F by a utility company. The facility power system F may provide a source of power to a plurality of outlets OUT located within the facility (e.g., as may be disposed in communication wit. However, it will be appreciated that other configurations are contemplated, and the external power source 157 could be configured or otherwise defined as power supplied from any suitable source (e.g., via a utility company, via a generator, and the like) in the form of Alternating Current or Direct Current power at any suitable voltage, frequency, and/or current for charging the battery 159 of the patient support apparatus 100.

In the illustrated version, the power converter 164 is coupled to the support structure 102 of the patient support apparatus 100 and is disposed in electrical communication with the battery 159 to facilitate charging of the battery 159 via power from the external power source 157 (herein, the power converter 164 may be interchangeably referred to as “the charger 164”). To this end, in some versions, the external power source 157 may provide Alternating Current power (e.g., 110-220 VAC at 50-60 Hz) as an input to the power converter 164 which, in turn, may output Direct Current power (e.g., 12-60 VDC) that is used to charge the battery 159. In some versions, the power converter 164 may also be utilized to generate or otherwise output power at a voltage, current, and/or frequency that can be used to operate powered devices PD when the apparatus interface 200 and the facility interface 300 are engaged in the connected state SC. Put differently, power for powered devices PD may be drawn from the battery 159 and/or from the power converter 164 in some versions, such as to simultaneously charge the battery 159 and facilitate operation of powered devices PD without depleting charge from the battery 159 during operation in the connected state SC. In some versions, the power converter 164 may also be configured to provide Alternating Current power to an auxiliary outlet carried onboard of the patient support apparatus 100 (e.g., acting as a power inverter; not shown). Other configurations are contemplated. While the power converter 164 is shown as a part of the patient support apparatus 100 in the illustrated version, it will be appreciated that the power converter 164 could be realized as a part of the facility power system F in some versions, such as to provide Direct Current voltage power P to the patient support apparatus 100. Similarly, it is contemplated that multiple power converters 164 may be utilized by the patient support system 98, either as a part of the patient support apparatus 100 and/or the facility power system F. Other configurations are contemplated.

As noted above, the charging connection system 198 may be employed to facilitate the transfer of both power P and data D between the facility power system F and the patient support apparatus 100. Here, it will be appreciated that various types of data D may be transferred between the facility power system F and the patient support apparatus 100, according to various communication protocols, standards, and the like. Data D may represent or be associated with various aspects of the facility power system F, the patient, the patient support apparatus 100, and/or other medical devices, systems, and the like. Other configurations are contemplated. In some versions, data D may be exchanged between the apparatus controller 156 and the infrastructure controller 186 to facilitate operation of the power converter 164, as described in greater detail below. In some versions, data D may be exchanged between the apparatus controller 156 and the infrastructure controller 186 to facilitate communication with the patient via video, audio, and the like. In some versions, the infrastructure controller 186 may facilitate communication with other external systems 188 of the facility power system F (e.g., nurse call systems, monitoring systems, management systems, other medical devices or equipment, and the like). Other configurations are contemplated.

In the representative version depicted in FIG. 1, in order to facilitate wired electrical communication between the patient support apparatus 100 and the facility power system F, the facility interface 300 includes a facility module 301 (also referred to herein as a facility housing), which is coupled to the source of power. In the version depicted in FIG. 1, the facility module 301 is coupled to an outlet OUT via a tether and plug, where the outlet OUT provides power to the facility module 301 from the facility power system F. The facility interface 300 also includes a tether T extending between the facility and an interface connector 302, with the tether T also being connected to the facility power system F (e.g., wired to the external power source 157 via the facility module). This configuration allows a caregiver or another user to move the facility interface 300 relative to the patient support apparatus 100 and bring it into and out of engagement with the apparatus interface 200 in the connected state SC as described in greater detail below. In the illustrated version, the apparatus interface 200 is depicted as being operatively attached to the intermediate frame 108 of the litter 106 adjacent to the head end. However, it will be appreciated that the apparatus interface 200 could be operatively attached to, or formed integrally with, any suitable portion of the patient support apparatus 100. Furthermore, it is contemplated that multiple apparatus interfaces 200 could be employed, such as to enable connection to one apparatus interface 200 arranged at the head end and/or to a different apparatus interface 200 arranged at the foot end (not shown). Other configurations are contemplated. It will be appreciated that the tether T may have any suitable length sufficient to facilitate releasable engagement of the charging connection system 198 in the connected state SC, or may be omitted in some versions.

While the tether T is shown coupled to the facility interface 300 to facilitate positioning relative to the apparatus interface 200 in the illustrated version, this arrangement could be different in other versions, such as with the tether coupled to the apparatus interface 200 and to another portion of the patient support apparatus 100 (not shown). In some versions, multiple tethers T could be employed, such as with one tether T coupled to the facility interface 300 and to another part of the facility power system F, and with another tether T coupled to the apparatus interface 200 and to another portion of the patient support apparatus 100 (not shown). Other configurations are contemplated.

As is described in greater detail below, the charging connection system 198 affords significant advantages to caregivers by enabling power P and/or data D to be exchanged between the facility power system F and the patient support apparatus 100 reliably and quickly based, among other things, on how the apparatus interface 200 and the facility interface 300 engage together in the connected state SC, and also can be quickly moved out of the connected state SC in a “breakaway” fashion in response to external contact or applied force. It will be appreciated that a breakaway of the charging connection system 198 depicted in FIG. 1 would result in the tether T and the facility interface 300 disconnecting from the apparatus interface 200, thereby allowing the patient support apparatus 100 to be moved away from the tether T and the interface connector 302. Here too, other configurations are contemplated, including without limitation the schematically-depicted version depicted in FIG. 2, which omits the facility module 301, and which illustrates another apparatus interface 200′ and another facility interface 300′ to represent multiple breakaways (e.g., one on each end of the tether T), and/or to represent breakaway at the facility power system F rather than breakaway at the patient support apparatus 100.

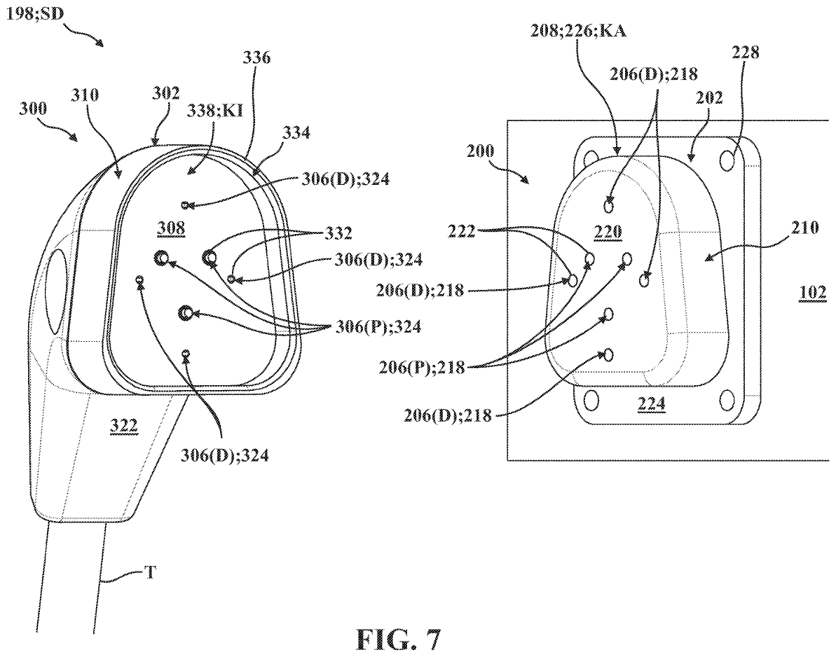

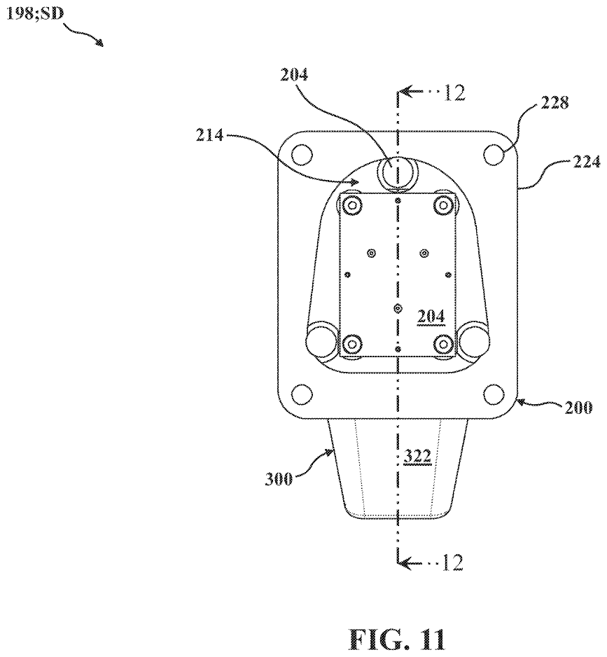

Referring now, generally, to FIGS. 7-12C, as noted above, the apparatus interface 200 and the facility interface 300 are configured for releasable engagement together in a connected state SC to facilitate wired electrical communication of power P and/or data D between the patient support apparatus 100 and the facility power system F. The apparatus interface 200 generally includes an apparatus connector 202, an apparatus magnetic element 204, and an apparatus terminal 206. The apparatus connector 202 is operatively attached to the support structure 102 of the patient support apparatus 100 and supports the apparatus magnetic element 204 and the apparatus terminal 206 as described in greater detail below. The apparatus terminal 206 is disposed in electrical communication with the control system 154 of the patient support apparatus 100, such as via a physical electrical connection to the apparatus controller 156, the battery 159, and/or the power converter 164. The facility interface 300 is configured for providing selective connection to the external power source 157 to charge the battery 159 of the patient support apparatus 100, and generally includes an interface connector 302, an interface magnetic element 304, an interface terminal 306 that is disposed in electrical communication with the external power source 157, and a face 308. The tether T extending between the facility module 301 and the interface connector 302 electrically couples the interface terminal 306 with power provided by the facility power system F.

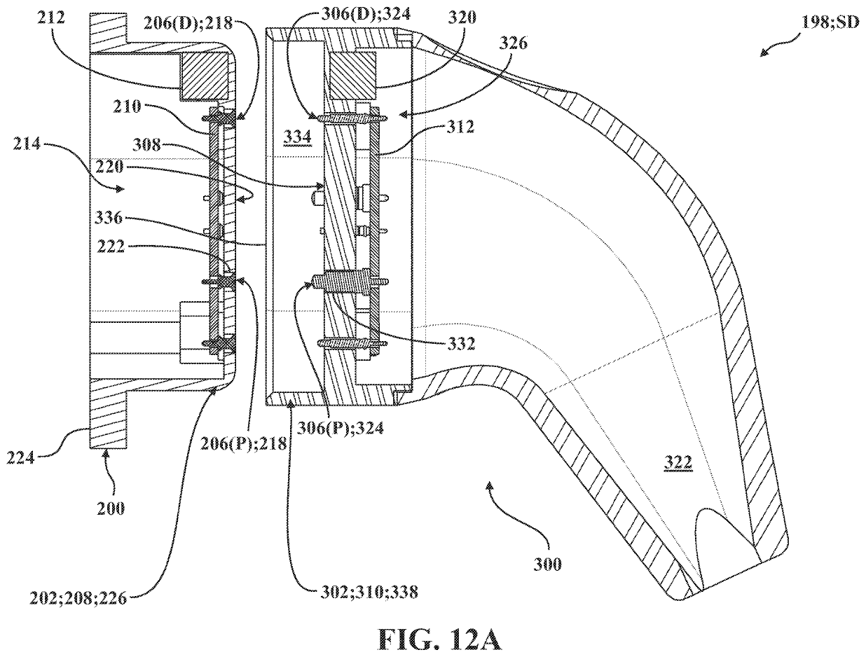

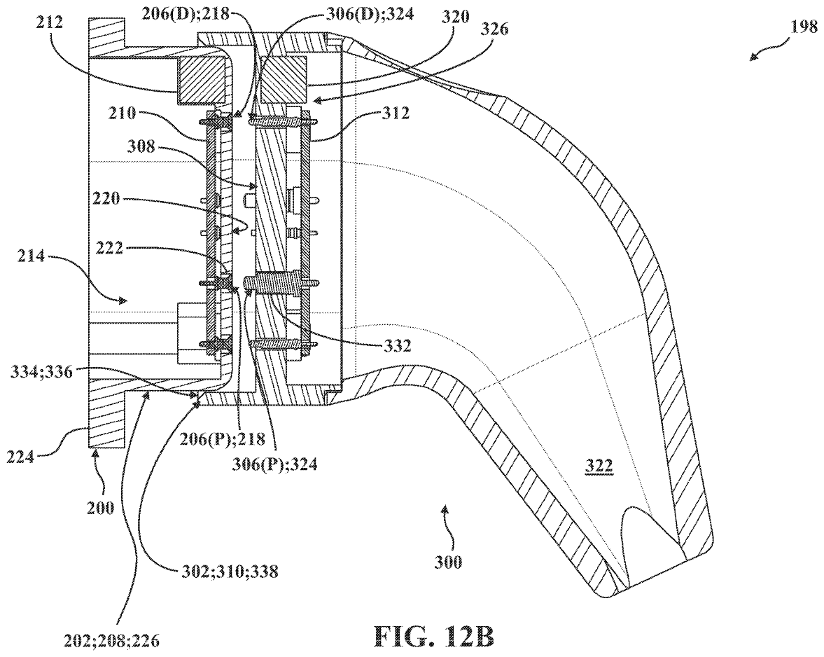

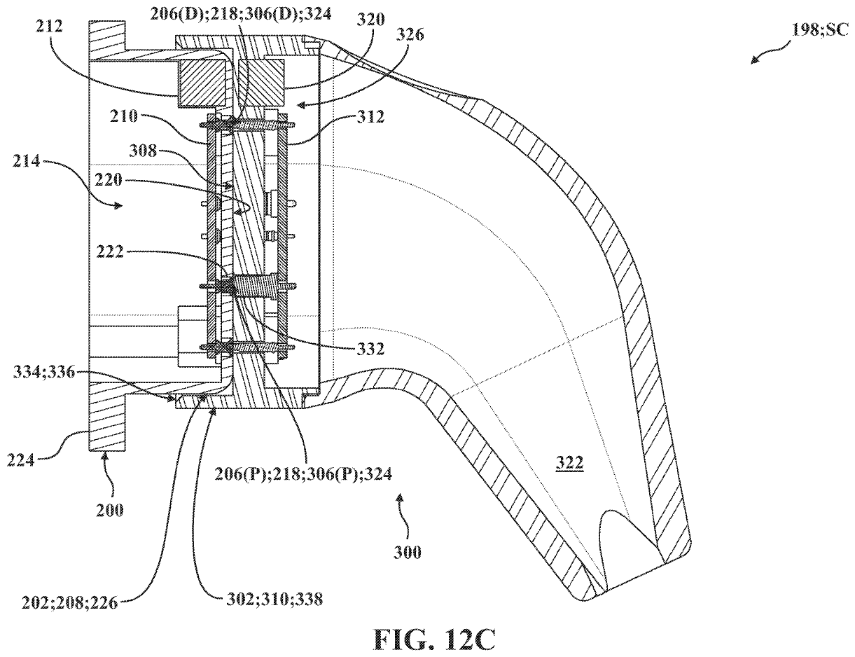

The facility interface 300 is operable with the interface terminal 306 arranged relative to the face 308 for abutment with the apparatus terminal 206 (see FIG. 12C) in response to magnetic attraction occurring between the apparatus magnetic element 204 and the interface magnetic element 304 to releasably couple the apparatus interface 200 and the facility interface 300 in the connected state SC with the apparatus terminal 206 abutting the interface terminal 306 to facilitate charging the battery 159 with power P from the external power source 157. In some versions, the facility interface 300 may be configured similar to as is described in U.S. Provisional Patent Application No. 63/427,211 filed on Nov. 22, 2022, entitled “Systems For Electrically Connecting Patient Support Apparatuses To Facilities,” the disclosure of which is hereby incorporated by reference in its entirety.

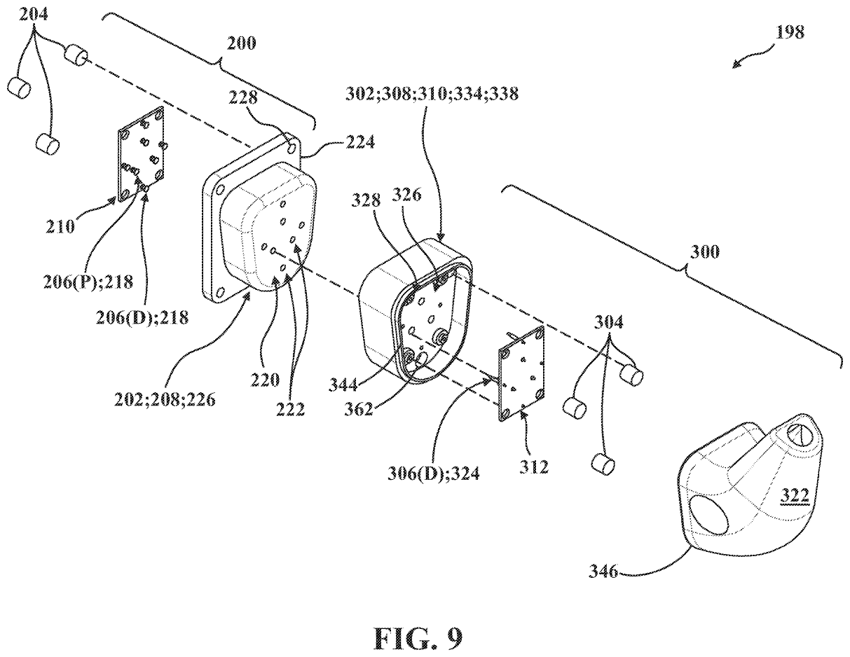

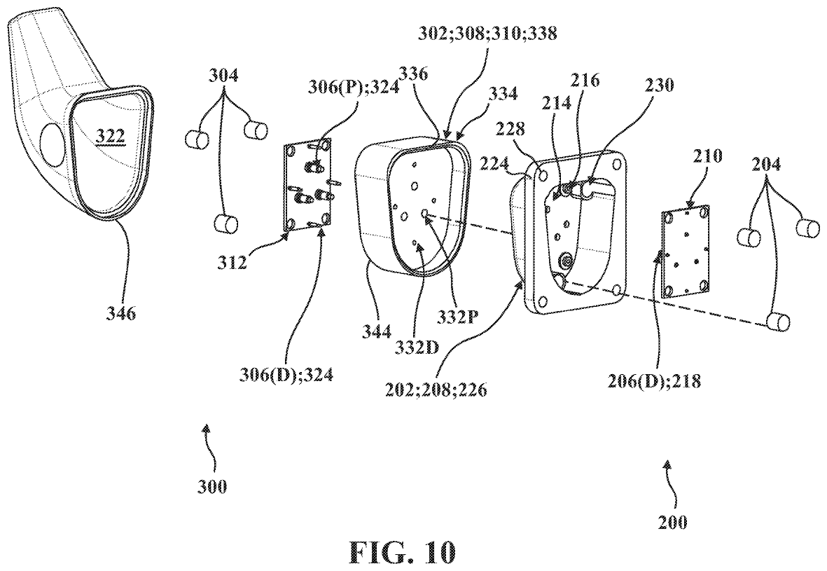

FIGS. 9-10 depict various components of the apparatus interface 200 and the facility interface 300. The apparatus interface 200 is shown having an apparatus housing 208, an apparatus circuit board 210 supporting a plurality of apparatus terminals 206, and a plurality of auxiliary apparatus magnetic elements 212; and the facility interface 300 is shown having an interface housing 310, an interface circuit board 312 supporting a plurality of interface terminals 306, and a cover 322. Each of the components of the apparatus interface 200 and the facility interface 300 introduced above will be described in greater detail below.

The apparatus housing 208 supports the apparatus terminal 206. More specifically, in the illustrated version, the apparatus housing 208 defines an apparatus pocket 214 in which an apparatus board mount 216 is disposed. The apparatus board mount 216 is shaped and arranged to support the apparatus circuit board 210 (e.g., via one or more fasteners; not shown) which, in turn, supports a plurality of apparatus terminals 206 relative to the apparatus housing 208. In the illustrated version, the apparatus circuit board 210 supports a plurality of apparatus power terminals 206P for transmitting power P, and a plurality of apparatus data terminals 206D for transmitting data D. In the illustrated version, three apparatus power terminals 206P and three interface power terminals 306P (see FIG. 7) are provided to facilitate transferring power P in the connected state SC, such as to transfer Alternating Current power P across three wires (e.g., neutral, hot, and ground, or other wires; not shown). However, it will be appreciated that different quantities of apparatus power terminals 206P and/or interface power terminals 306P may be utilized in some versions (e.g., more than three or fewer than three). In the illustrated version, four apparatus data terminals 206D and four interface data terminals 306D (see FIG. 7) are provided to facilitate transferring data D in the connected state SC, such as to transfer data D across four wires (e.g., power, ground, transmit, receive, or other wires; not shown). Here too, it will be appreciated that different quantities of apparatus data terminals 206D and/or interface data terminals 306D may be utilized in some versions (e.g., more than four or fewer than four).

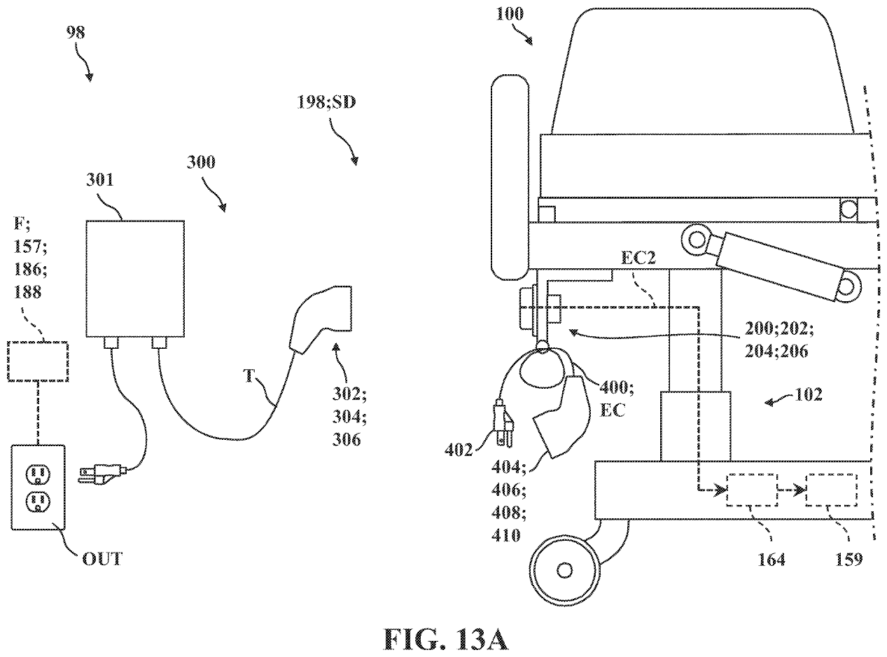

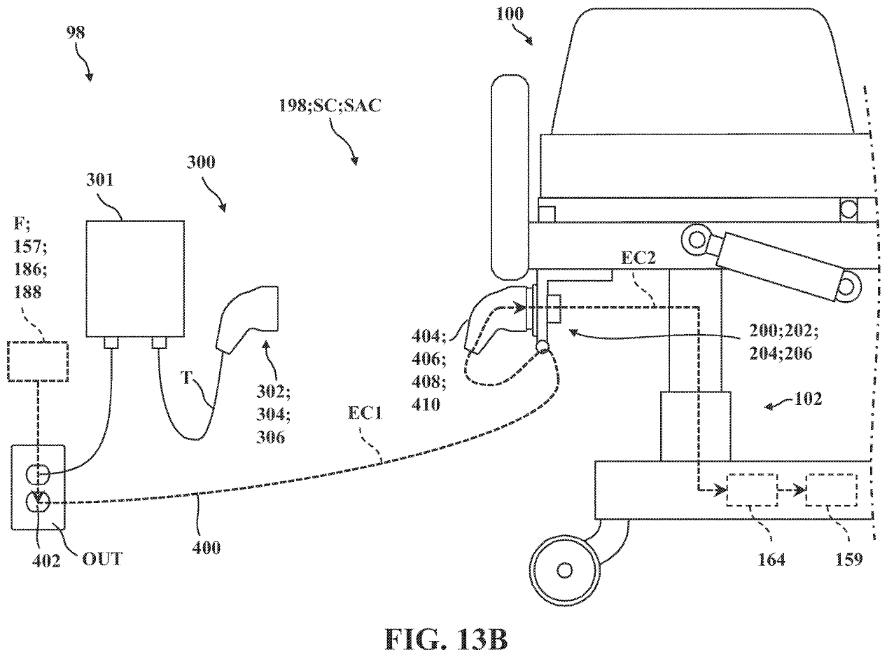

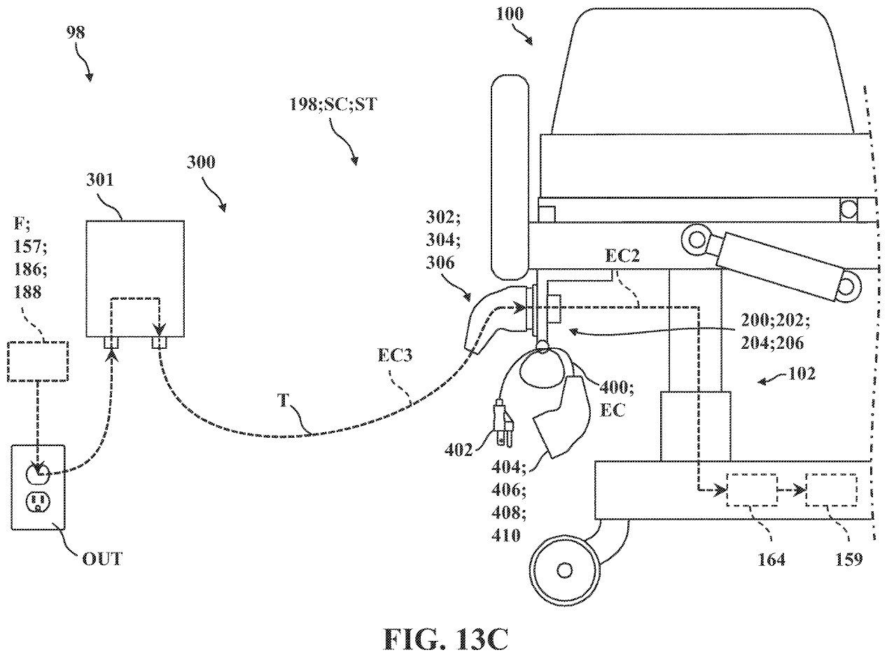

In the illustrated version, the apparatus terminals 206 coupled to the apparatus circuit board 210 such as by soldering. The apparatus terminals 206 each define respective contact pads 218 which are shaped and arranged to abut corresponding contact faces 324 of the interface terminals 306 in the connected state SC (see FIG. 7). In some versions, one or more apparatus terminals 206 and/or interface terminals 306 may be realized as “pogo pins” or may otherwise facilitate at least partial resilient deflection or movement to help ensure contact during abutment in the connected state SC (see FIGS. 12C and 13D; abutment shown in exaggerated detail for illustrative purposes). However, it will be appreciated that other configurations are contemplated, and the apparatus terminals 206 and/or interface terminals 306 could be of other types, styles, and/or arrangements sufficient to transmit power P and/or data D in the connected state SC.

As is best shown in FIG. 9, in the illustrated version, the apparatus housing 208 of the apparatus connector 202 defines an apparatus contact face 220 and a plurality of contact face apertures 222 formed in the apparatus contact face 220. Here, the plurality of apparatus terminals 206 are supported in the contact face apertures 222 with their respective contact pads 218 arranged so as to be substantially flush with the apparatus contact face 220. It will be appreciated that this configuration substantially improves cleanability and inhibits the buildup of contaminants along the apparatus contact face 220, where contaminants might otherwise collect along the apparatus contact face 220. Here too in this version, the apparatus housing 208 defines a flange 224 and a plug 226 extending from the flange 224 and merging into the apparatus contact face 220 with a keyed profile KA (see FIG. 7) that is generally smooth and helps promote cleanability, whereby the apparatus contact face 220 and/or the plug 226 can be readily wiped down if exposed to contaminants. The flange 224 of the apparatus housing 208 defines flange mounts 228 to facilitate attachment to the support structure 102, such as with fasteners (not shown). However, as noted above, one or more portions of the apparatus connector 202 may be formed integrally with other components of the patient support apparatus 100 in some versions, such as where the plug 226 may be formed as a part of a barrier such as the headboard 136. Other configurations are contemplated.

In the illustrated version, the apparatus housing 208 supports one or more apparatus magnetic elements 204. To this end, and as is best depicted in FIG. 10, the apparatus housing 208 defines a plurality of apparatus magnet mounts 230 arranged in the apparatus pocket 214 and shaped to receive one of the apparatus magnetic elements 204. In the illustrated version, three apparatus magnetic elements 204 and three interface magnetic elements 304 are provided. Here, the apparatus magnetic elements 204 and the interface magnetic elements 304 are configured and arranged with respect to each other so as to facilitate operation in the connected state SC based on magnetic attraction, such as by orientating the apparatus magnetic elements 204 and the interface magnetic elements 304 with opposing magnetic poles facing towards each other in the connected state SC in versions where the apparatus magnetic element 204 and the interface magnetic element 304 are each realized as magnets. In some versions, the apparatus magnetic element 204 could be a magnet, and interface magnetic element 304 could be manufactured from a material which can be attracted magnetically (e.g., steel). Other configurations are contemplated. While the representative version illustrated throughout the drawings employs three apparatus magnetic elements 204 and three interface magnetic elements 304, it will be appreciated that other quantities of magnetic elements (e.g., more than three or fewer than three) could be employed by the apparatus interface 200 and/or by the facility interface 300, and the magnetic elements could be of various types, styles, configurations and may be disposed in different orientations and/or arrangements.

As noted above, magnetic attraction occurring between the apparatus magnetic element 204 and the interface magnetic element 304 retains the charging connection system 198 in the connected state CS. Put differently, the apparatus interface 200 and the facility interface 300 may be configured with one or more apparatus magnetic elements 204 and one or more interface magnetic elements 304 which are sized or otherwise configured to maintain abutment between the apparatus terminal 206 and the interface terminal 306 in absence of external forces acting on the interface connector 302 and/or acting between the interface connector 302 and the apparatus connector 202. In some versions, magnetic attraction occurring between one or more auxiliary apparatus magnetic elements and one or more auxiliary interface magnetic elements may at least partially retain the charging connection system 198 in the connected state CS. Here too, it will be appreciated that auxiliary apparatus magnetic elements and/or auxiliary interface magnetic elements may be employed to increase the amount of applied external force required to move the charging connection system 198 out of the connected state SC and into a disconnected state SD, and/or may be employed to increase resistance to movement out of the connected state SC in response to the application of external force in specific directions, such as to resist disconnection when a specific amount of external force is applied along the axis A but to promote disconnection when that same amount of external force is applied transverse to the axis A. Other configurations are contemplated, and it will be appreciated that the auxiliary apparatus magnetic elements and the auxiliary interface magnetic elements may be omitted in some versions.

With continued reference to FIGS. 9-10, in the illustrated version, the facility interface 300 employs the interface circuit board 312 to support a plurality of interface data terminals 306D for transmitting data D and power terminals 306P for transmitting power P. The interface housing 310 defines an interface pocket 326 in which an interface board mount 328 is disposed. The interface board mount 328 is shaped and arranged to support the interface circuit board 312 (e.g., via one or more fasteners; not shown) which, in turn, supports a plurality of interface terminals 306 relative to the interface housing 310. The interface housing 310 of the interface connector 302 defines the face 308 in the illustrated version which is arranged to abut the apparatus contact face 220 in the connected state SC (see FIG. 12C). The face 308 of the interface housing 310 also defines a plurality of face apertures 332 for the respective plurality of interface terminals 306 in the illustrated version. More specifically, a total of three power face apertures 332P are provided for the three interface power terminals 306P, and a total of four data face apertures 332D are provided for the four interface data terminals 306D in the illustrated version. Furthermore, in some versions, the facility interface 300 and/or the apparatus interface 200 could employ a carriage (not shown) to support one or more terminals for movement relative to its a shield, such as where the power P being transferred is relatively high voltage Direct Current power P with apparatus power terminals coupled to a relatively high voltage battery 159. Other configurations are contemplated.

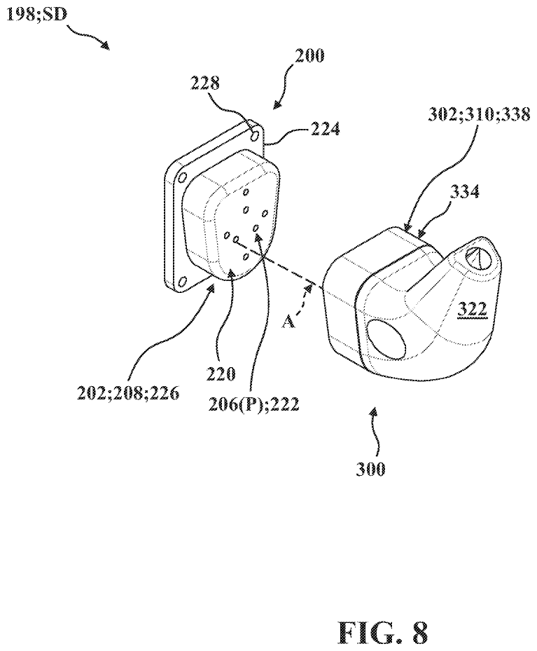

In the illustrated version, the interface housing 310 also includes a lip 334 which extends away from the face 308 to a lip edge 336 to define a socket 338 shaped to receive the plug 226 of the apparatus interface 200 in the connected state SC (see FIG. 12C). Here, the socket 338 is arranged to receive the plug 226 in keyed alignment to couple the facility interface 300 and the apparatus interface 200 in the connected state SC. More specifically, in the illustrated version, the socket 338 of the facility interface 300 has a keyed profile KI which is complimentary to the keyed profile KA of the plug 226 of the apparatus interface 200 (see FIG. 7). Here, the keyed profiles KA, KI are shaped to releasably engage each other in keyed alignment along the axis A. Here, the apparatus terminals 206 and the interface terminals 306 are arranged relative to each of the respective keyed profiles KA, KI to facilitate alignment between the apparatus terminals 206 and the interface terminals 306 in response to engagement in the connected state SC occurring in keyed alignment along the axis A (see FIG. 8). Here too, the complimentary keyed profiles KA, KI of the apparatus connector 202 and the interface connector 302 are configured to inhibit releasable engagement with each other during an absence of keyed alignment occurring along the axis A. The lip 334 encompasses the face 308 and is arranged to abut the plug 226 to prevent coupling in the connected state SC during an absence of keyed alignment between the plug 226 and the socket 338. In the illustrated version, the lip edge 336 is spaced from the face 308 at a lip distance, and the magnetic attraction between the apparatus magnetic element 204 and the interface magnetic element 304 occurs in response to the interface magnetic element 304 being within a threshold distance of the apparatus magnetic element 204, with the lip distance being larger than the threshold distance. This configuration helps facilitate initial positioning of the interface connector 302 relative to the apparatus connector 20 in that the interface magnetic element 304 and the apparatus magnetic element 204 stay spaced away from each other at a distance that is larger than the threshold distance when misaligned contact occurs between the lip 334 and portions of the plug 226 (e.g., the apparatus contact face 220).

As is best depicted in FIG. 9, in the illustrated version, the interface housing 310 defines a shell flange 344 adjacent to the interface pocket 326 which is configured to engage the cover 322 of the interface connector 302. In the illustrated version, the cover 322 has a generally hollow, shell-like profile that is shaped to, among other things, route wires from the tether T to the interface terminals 306, facilitate ergonomic handling of the facility interface 300, and generally inhibit ingress of contaminants towards internal components of the facility interface 300. The cover 322 has a cover flange 346 that is shaped to engage the shell flange 344 to attach the cover 322 to the interface housing 310, such as by a “snap fit” engagement. However, other configurations are contemplated, and the cover 322 could be operatively attached to the interface housing in a number of different ways, including such as by adhesives, ultrasonic welding, and/or other forms of mechanical connections. While the cover 322 may be formed as a separate component from the interface housing 310 to, among other things, facilitate assembly of the facility interface 300 during manufacturing, it is contemplated that the interface connector 302 could be configured in other ways, such as with all or a portion of the cover 322 being formed integrally with the interface housing 310. Similarly, while the illustrated version of the facility interface 300 depicts the face 308 and other portions of the interface connector 302 as being formed integrally with the interface housing 310, it will be appreciated that these and other components could be formed separately and operatively attached to the interface housing 310, either directly or indirectly in a number of different ways.

In this way, the configuration of the apparatus interface 200 and the facility interface 300 of the charging connection system 198 affords significant opportunities for improved usability and safety associated with operating patient support apparatuses 100 which employ powered devices PD driven by batteries 159. By way of illustrative example, in scenarios where the facility power system F is configured such that the external power source 157 provides Alternating Current power (e.g., 110-220 VAC at 50-60 Hz), the face 308 promotes significantly safe handling of the facility interface 300 via the face 308 limiting contact of the interface power terminals 306P with environmental objects such as the caregiver's body, portions of the patient support apparatus 100, or other objects across which power P could otherwise be transferred (e.g., conventional electrical connectors with “hot” contacts; not shown). Furthermore, the breakaway functionality afforded by the charging connection system 198 helps prevent inadvertent damage to the apparatus interface 200 and the facility interface 300, as well as to other portions of the patient support apparatus 100 and the facility power system F. Here too it will be appreciated that movement of the interface connector 302 away from the apparatus connector 202, such as resulting from external force acting between the apparatus connector 202 and the interface connector 302 which releases the apparatus connector 202 and the interface connector 302 from the connected state SC, allows the patient support apparatus 100 to be safely and quickly moved away from the facility interface 300 in the disconnected state SD whether or not the external force was intentional or unintentional. Moreover, the charging connection system 198 affords opportunities for improved charging of the battery 159 of the patient support apparatus 100 in that the caregiver can quickly and easily attach the apparatus interface 200 and the facility interface 300 together in the connected state CS to facilitate charging the battery 159 with power P from the external power source 157 of the facility power system F.

In some instances, the charging connection system 198 may include an auxiliary charging cable 400. The auxiliary charging cable 400 is shown in FIG. 1. The auxiliary charging cable extends to a plug 402 configured to releasably couple to one or more of the plurality of outlets OUT of the facility power system F. The auxiliary charging cable 400 allows for charging of the battery 159 without coupling the apparatus interface 200 and the facility interface 300. Advantageously, a user of the patient support apparatus 100 may charge the battery 159 in locations of the facility that do not include the facility interface 300 but include an outlet OUT in electrical communication with the facility power system F. In one such example, the patient support apparatus 100 may be charged in a hallway of a hospital, where the hallway does not include a facility interface 300 but includes an outlet OUT in electrical communication with the facility power system F.

FIGS. 13A-16D illustrate instances of the charging connection system 198. In each of the instances, the charging connection system 198 is selectively operable between a tether state ST and an auxiliary cable state SAC. In the tether state ST, the interface connector 302 is disposed in electrical communication with the charging connection system 198. In auxiliary cable state SAC, the plug 402 of the auxiliary charging cable 400 is disposed in electrical communication with the charging connection system 198 and where electrical communication is interrupted between the charging connection system 198 and the interface connector 302.

The charging connection system 198 may operate in only one of the tether state ST and the auxiliary cable state SAC at a time. This is because operation of the charging connection system 198 in the auxiliary cable state SAC interrupts electrical communication between the charging connection system 198 and the interface connector 302, where such an electrical communication occurs during operation of the charging connection system 198 in the tether state ST. Advantageously, by only operating in only one of the tether state ST and the auxiliary cable state SAC at a time, the charging connection system 198 operates in a safe manner, ensuring that the battery 159 does not receive alternating current power from two sources of alternating current power, as well as ensuring that alternating current power is not directed unexpectedly towards a connector, plug, terminal, and the like that is not actively being utilized.

In a first instance of the charging connection system 198, shown in FIGS. 1 and 13A-13C, the auxiliary charging cable 400 extends in electrical communication EC1 between the plug 402 and an auxiliary interface 404 having an auxiliary connector 406 supporting an auxiliary magnetic element 408 and an auxiliary terminal 410. Additionally, the apparatus interface 200 is disposed in electrical communication EC2 with the charger 164. The apparatus connector 202 may be shaped to receive the auxiliary connector 406. For example, the auxiliary connector 406 may be shaped and of similar structure to the above-described interface connector 302 such that the apparatus connector 202 may receive the auxiliary connector 406. However, in some versions the auxiliary connector 406 may have profile, shape, arrangement, and the like which differs from the interface connector 302 (e.g., with a flatter, smoother profile; not shown). The auxiliary charging cable 400 is operatively attached to the support structure 102 between the plug 402 and the auxiliary connector 406. As will be described below, the auxiliary connector 406 is movable relative to the apparatus connector 202 to change operation of the charging connection system 198 between the tether state ST and the auxiliary cable state SAC.

Referring to FIG. 13B, the plug 402 is disposed in electrical communication EC1, EC2 with the charging connection system 198. In such an instance, the apparatus connector 202 may be releasably coupled to the auxiliary connector 406 with the apparatus terminal 206 abutting the auxiliary terminal 410 in response to magnetic attraction occurring between the apparatus magnetic element 204 and the auxiliary magnetic element 408 to facilitate charging of the battery 159 with the facility power system F during operation of the charging connection system 198 in the auxiliary cable state SAC. Additionally, once the plug 402 is releasably coupled to an outlet OUT of the facility power system F, the electrical connection EC1, EC2 is formed between the facility power system F and the battery 159, and the charging connection system 198 operates in the connected state SC.

Referring to FIG. 13C, the interface connector 302 is disposed in electrical communication EC3, EC2 with the charging connection system 198. In such an instance, the apparatus connector 202 may be releasably coupled to the interface connector 302 with the apparatus terminal 206 abutting the interface terminal 306 in response to magnetic attraction occurring between the apparatus magnetic element 204 and the interface magnetic element 304 to facilitate charging of the battery 159 with the facility power system F during operation of the charging connection system 198 in the tether state ST. Additionally, because the facility power system F and the interface connector 302 are disposed in electrical communication EC3, once the apparatus connector 202 is coupled to the interface connector 302, an electrical connection EC3, EC2 is formed between the facility power system F and the battery 159, and the charging connection system 198 operates in the connected state SC.

In the instance of FIGS. 13A-13C, removal of the interface connector 302 from the apparatus connector 202 changes operation of the charging connection system 198 out of the tether state ST. Additionally, removal of the auxiliary connector 406 from the apparatus connector 202 changes operation of the charging connection system 198 out of the auxiliary cable state SAC. For example, in FIG. 13A, the interface connector 302 is removed from the apparatus connector 202, and the auxiliary connector 406 is removed from the apparatus connector 202. As follows, the charging connection system 198 in FIG. 13A is not operating in either the tether state ST or the auxiliary cable state SAC and operates in the disconnected state SD.

In the instance of FIGS. 13A-13C, the charging connection system 198 operates in only one of the tether state ST and the auxiliary cable state SAC because the apparatus connector 202 may only releasably couple to one of the auxiliary connector 406 and the interface connector 302 at a time. In this way, the charging connection system 198 of FIGS. 13A-13C ensures that alternating current power is not provided to the battery 159 from two sources of alternating current power.

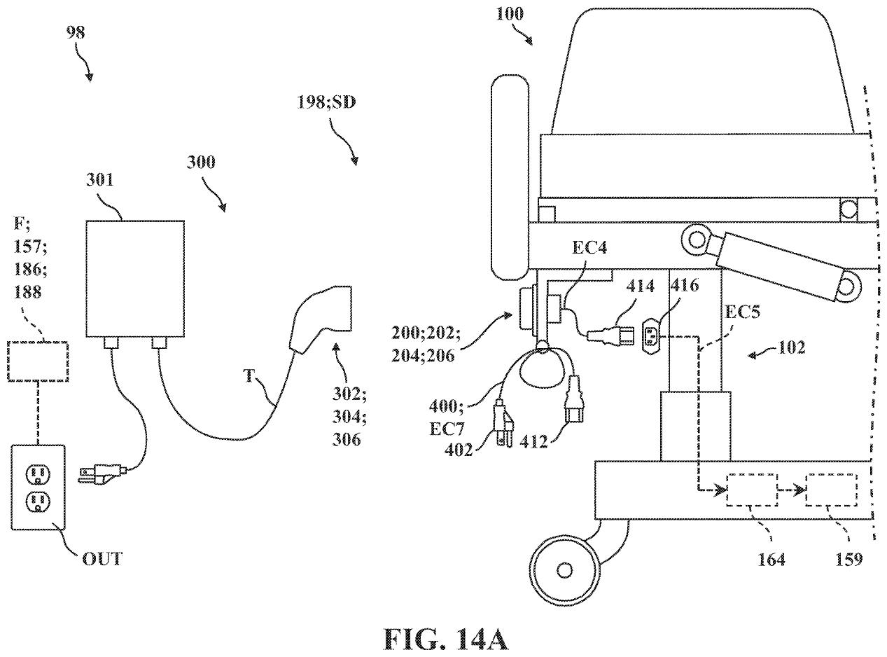

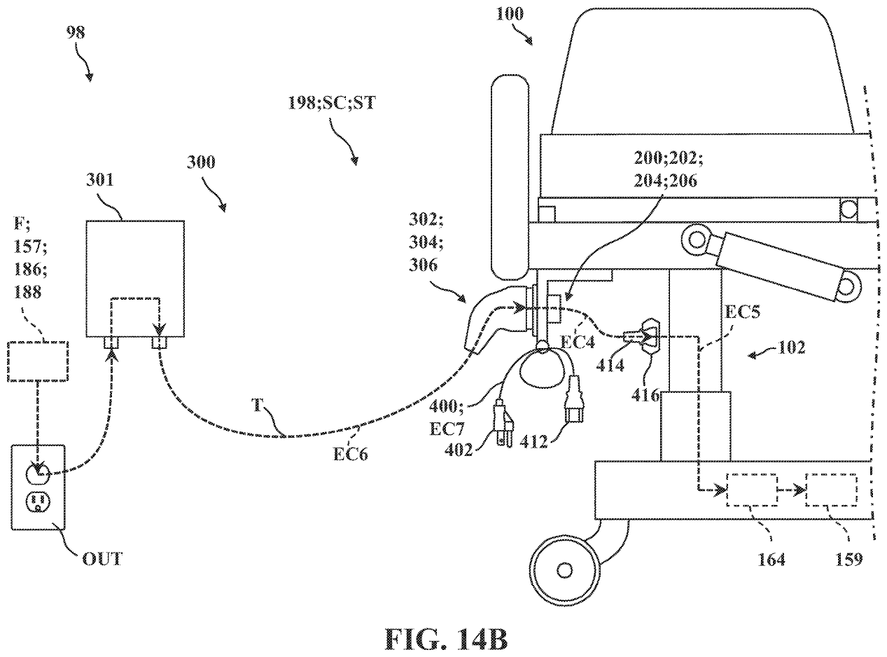

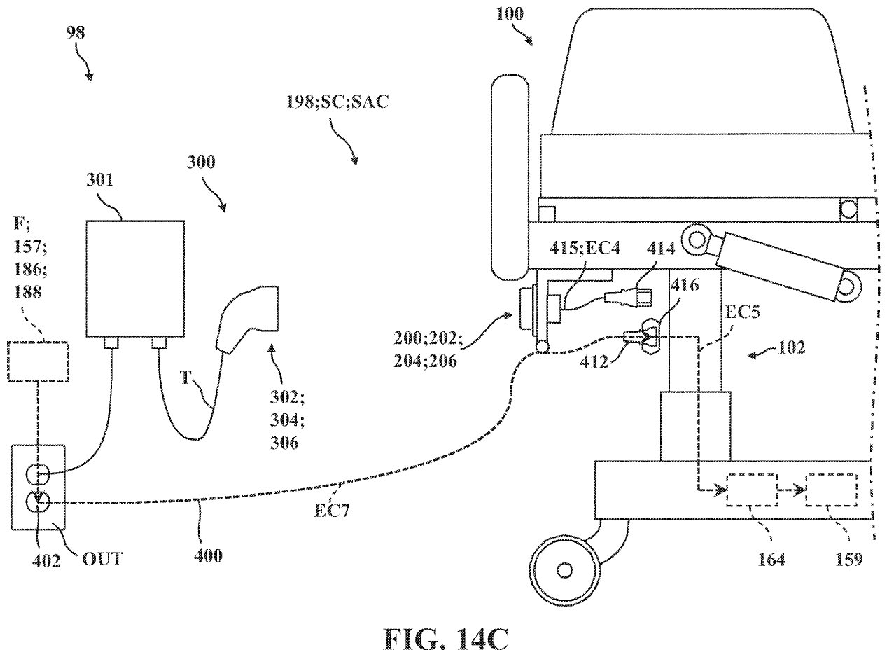

In a second instance of the charging connection system 198, which is shown in FIGS. 14A-14C, the apparatus interface 200 includes an apparatus plug 414 disposed in electrical communication EC4 with the apparatus connector 202. As shown, the apparatus connector 202 is operatively attached to the support structure 102 via the apparatus plug 414. Additionally, the auxiliary charging cable 400 extends in electrical communication EC7 between the plug 402 and a shielded plug 412, and the auxiliary charging cable 400 is operatively attached to the support structure 102 between the plug 402 and the shielded plug 412. Furthermore, the charging connection system 198 includes a socket 416 disposed in electrical communication EC5 with the charger 164, the socket 416 being shaped to receive one of the apparatus plug 414 and the shieled plug 412 at a time. As will be explained below, the socket 416 may be movable relative to the apparatus connector 202 to change operation of the charging connection system 198 between the tether state ST and the auxiliary cable state SAC.

The apparatus plug 414 and the shielded plug 412 may be any suitable plug, and the socket 416 may be any suitable corresponding socket for receiving one of the apparatus plug 414 and the shielded plug 412 at a time. For example, the apparatus plug 414 and the shielded plug 412 may be any one of a type A, B, C, D, E, F, F/G, G, H, I, J, K, L, M, or N plug and the socket 416 may be any one of a corresponding type A, B, C, D, E, F, F/G, G, H, I, J, K, L, M, or N socket. In a more specific example, the apparatus plug 414 and the shielded plug 412 may be IEC plugs and the socket 416 may be an IEC socket.

Referring to FIG. 14B, the socket 416 receives the apparatus plug 414 in the tether state ST. In the tether state ST, the apparatus interface 200 is placed in electrical communication EC4, EC5 with the charging connection system 198. Once the apparatus connector 202 receives the interface connector 302, an electrical connection EC6, EC4, EC5 is formed between the facility power system F and the battery 159, and the charging connection system 198 operates in the tether state ST and in the connected state SC.

Referring to FIG. 14C, the socket 416 receives the shielded plug 412 in the auxiliary cable state SAC. In the auxiliary cable state SAC, the auxiliary charging cable 400 is placed in electrical communication EC7, EC5 with the charging connection system 198. Once the plug 402 is releasably coupled to an outlet OUT of the facility power system F, the electrical connection EC7, EC5 is formed between the facility power system F and the battery 159, and the charging connection system 198 operates in the auxiliary cable state SAC and in the connected state SC.

In the instance of FIGS. 14A-14C removal of the apparatus plug 414 from the socket 416 changes operation of the charging connection system 198 out of the tether state ST. Additionally, removal of the shielded plug 412 from the socket 416 changes operation of the charging connection system 198 out of the auxiliary cable state SAC. For example, in FIG. 14A, the apparatus plug 414 is removed from the socket 416, and the shielded plug 412 is removed from the socket 416. As follows, the charging connection system 198 in FIG. 13A is not operating in either the tether state ST or the auxiliary cable state SAC and operates in the disconnected state SD.

In the instance of FIGS. 14A-14C, the charging connection system 198 operates in only one of the tether state ST and the auxiliary cable state SAC because the socket 416 may only receive one of the shielded plug 412 and the apparatus plug 414 at a time. In this way, the charging connection system 198 of FIGS. 14A-14C ensures that alternating current power is not provided to the battery 159 from two sources of alternating current power.

As previously stated, the socket 416 may be movable relative to the apparatus connector 202 to change operation of the charging connection system 198 between the tether state ST and the auxiliary cable state SAC. For example, the socket 416 may be tethered to the charger 164 such that the socket 416 may be movable relative to the apparatus connector 202 to receive the shielded plug 412 and the apparatus plug 414. However, in other instances, the socket 416 may be fixed to the support structure 102. In such instances, the apparatus plug 414 may be movable relative to the apparatus connector 202 to be received by the socket 416 and the shielded plug 412 may be movable relative to the apparatus connector 202 to be received by the socket 416. For example, the apparatus plug 414 may be disposed in electrical communication EC4 with the apparatus connector 202 via a tether 415, as shown in FIG. 14C. The tether 415 may include a sufficient length to allow the apparatus plug 414 to be received by the socket 416. Additionally, the auxiliary charging cable 400 may include a sufficient length to allow the shielded plug 412 to be received by the socket 416.

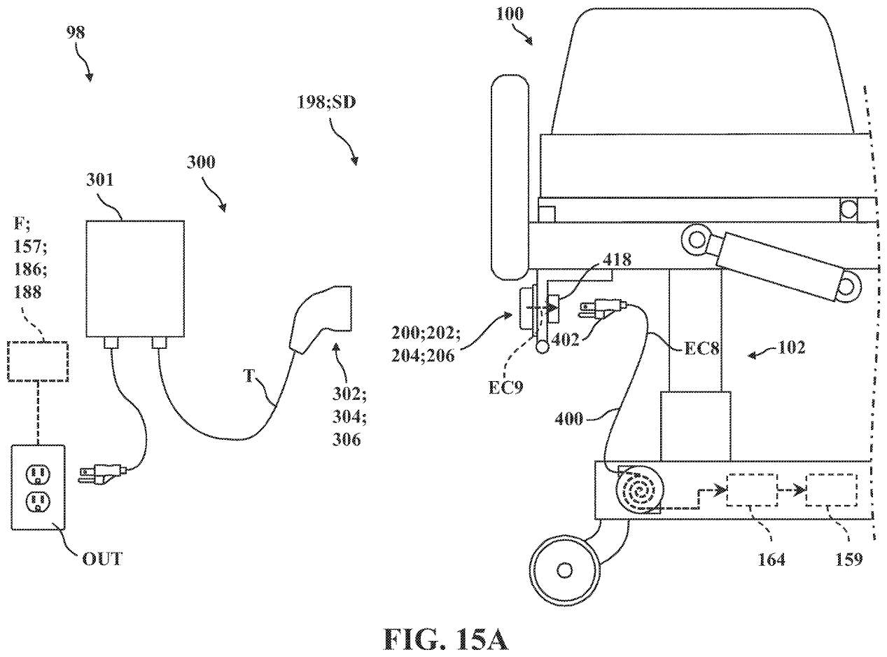

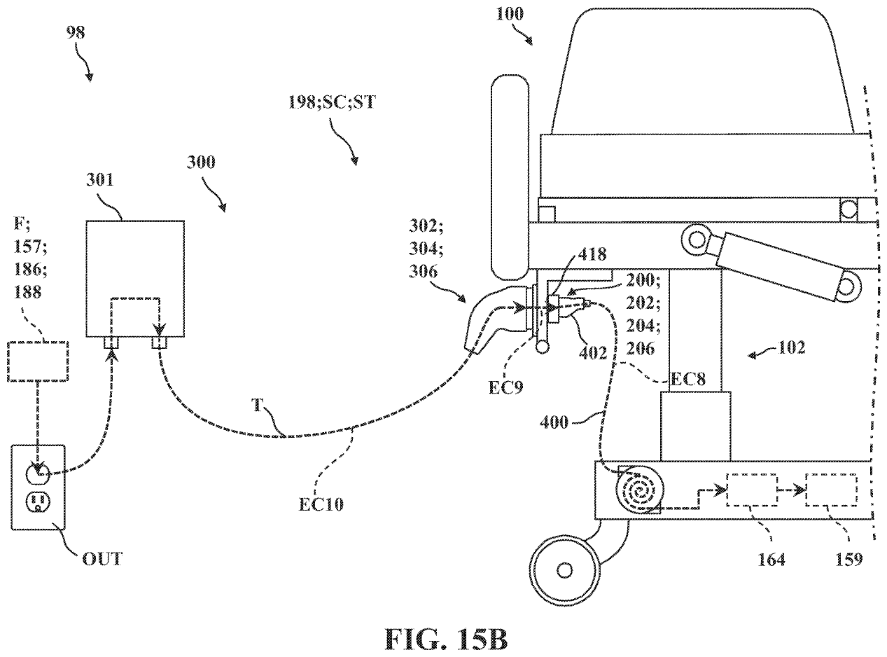

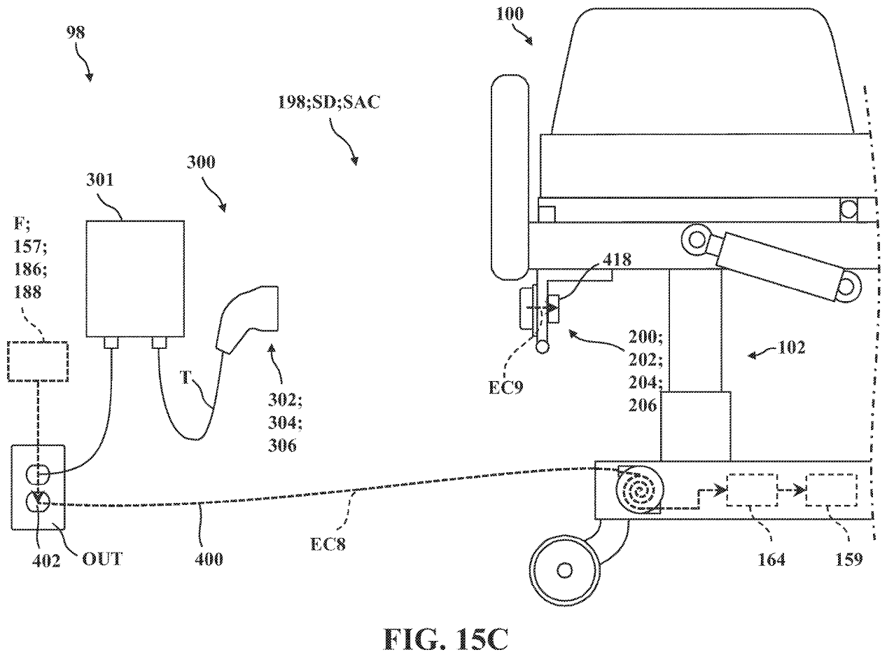

In a third instance of the charging connection system 198, which is shown in FIGS. 15A-15C, the auxiliary charging cable 400 extends in electrical communication EC8 between the plug 402 and the charger 164. Additionally, the apparatus interface 200 includes an apparatus socket 418 disposed in electrical communication EC9 with the apparatus connector 202 and shaped to receive the plug 402 of the auxiliary charging cable 400. The apparatus connector 202 is operatively attached to the support structure 102 via the plug 402 and the auxiliary charging cable 400. As will be explained below, the plug 402 is movable relative to the apparatus connector 202 to change operation of the charging connection system 198 between the tether state ST and the auxiliary cable state SAC.

Referring to FIG. 15B, the apparatus socket 418 receives the plug 402 of the auxiliary charging cable 400 in the tether state ST. In the tether state ST, the apparatus interface 200 is placed in electrical communication EC9, EC8 with the charging connection system 198. Once the apparatus connector 202 receives the interface connector 302, an electrical connection EC10, EC9, EC8 is formed between the facility power system F and the battery 159, and the charging connection system 198 operates in the tether state ST and in the connected state SC.

Referring to FIG. 15C, the plug 402 is releasably coupled to an outlet OUT of the facility power system F in the auxiliary cable state SAC. In the auxiliary cable state SAC, the electrical connection EC8 is formed between the facility power system F and the battery 159, and the charging connection system 198 operates in the auxiliary cable state SAC and in the connected state SC.

In the instance of FIGS. 15A-15C removal of the plug 402 from the apparatus socket 418 changes operation of the charging connection system 198 out of the tether state ST. For example, in FIG. 15A, the plug 402 is removed from the apparatus socket 418 and the charging connection system 198 is not operating in the tether state ST and operates in the disconnected state SD. Additionally, removal of the plug 402 from an outlet OUT of the facility power system F changes operation of the charging connection system 198 out of the auxiliary cable state SAC. For example, in FIG. 15A, the plug 402 is removed from an outlet OUT of the facility power system F and the charging connection system 198 is not operating in the auxiliary cable state SAC and operates in the disconnected state SD.

In the instance of FIGS. 15A-15C, the charging connection system 198 operates in only one of the tether state ST and the auxiliary cable state SAC because the plug 402 of the auxiliary charging cable 400 may only be received by one of the apparatus socket 418 and an outlet OUT of the facility power system F at a time. In this way, the charging connection system 198 of FIGS. 15A-15C ensures that alternating current power is not provided to the battery 159 from two sources of alternating current power.

As previously stated, the plug 402 is movable relative to the apparatus connector 202 to change operation of the charging connection system 198 between the tether state ST and the auxiliary cable state SAC. Specifically, the plug 402 may move from being received by the apparatus socket 418 to being received by an outlet OUT of the facility power system F. It is contemplated that the auxiliary charging cable 400 may include a length to accommodate movement of the plug 402 between the apparatus socket 418 and an outlet OUT of the facility power system F. Additionally, the patient support system 98 may include a cable retractor 420 to support the auxiliary charging cable 400, ensuring that the length of the auxiliary charging cable 400 does not become tangled with other components of the patient support system 98. Additionally, the cable retractor 420 may be configured to permit movement of the plug 402 between the apparatus socket 418 and the plurality of outlets OUT of the facility power system F. For example, in the instance of FIGS. 15A-15C, the cable retractor 420 is illustrated as a cord reel 420 configured to house the auxiliary charging cable 400. The plug 402 may be disposed at an end of the cord reel 420, allowing a user of the patient support system 98 to move the plug 402 between the apparatus socket 418 to being received by an outlet OUT of the facility power system F, while receiving a sufficient length of the auxiliary charging cable 400 from the cord reel 420. It is contemplated that, in other instances, the cable retractor 420 may include a different structure, and may be located at any suitable location in the patient support system 98. For example, in the instance of FIGS. 15A-15C, the cable retractor 420 is operatively attached to the support structure 102 of the patient support apparatus 100.

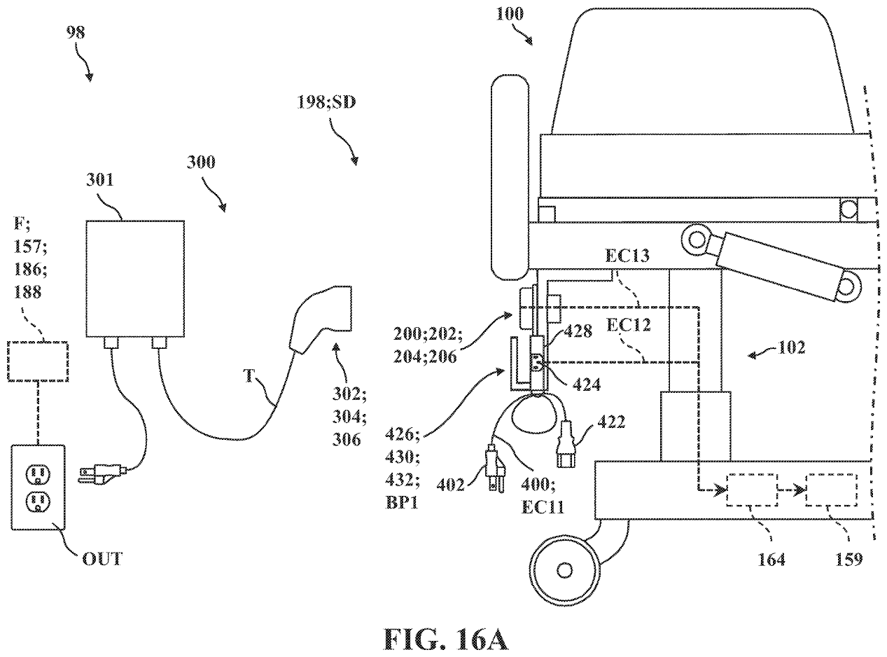

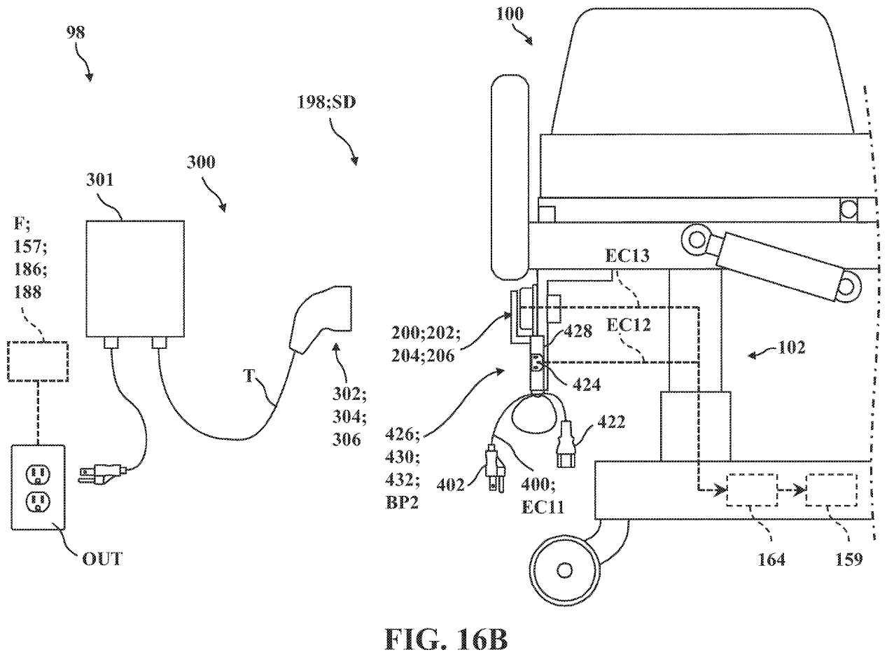

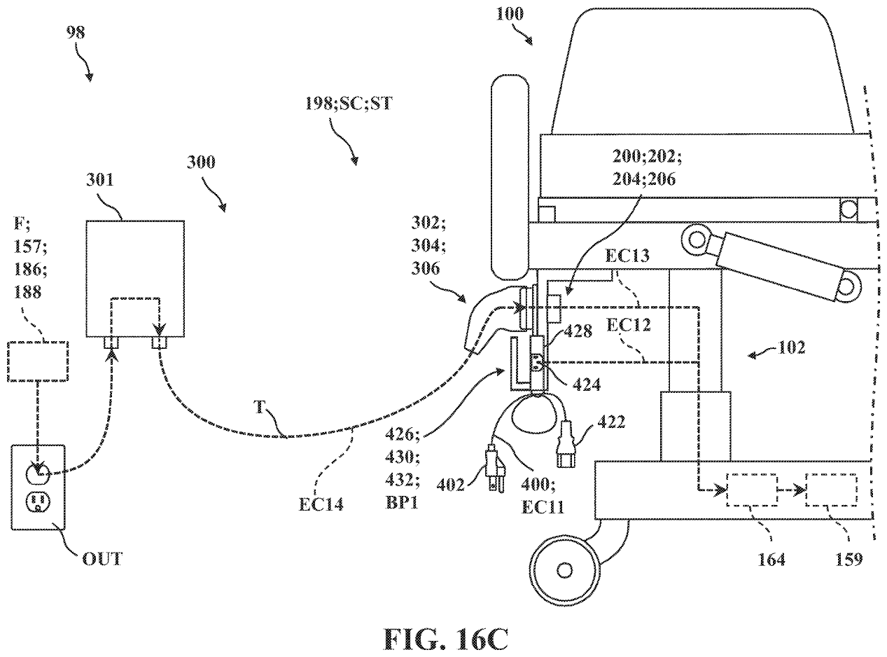

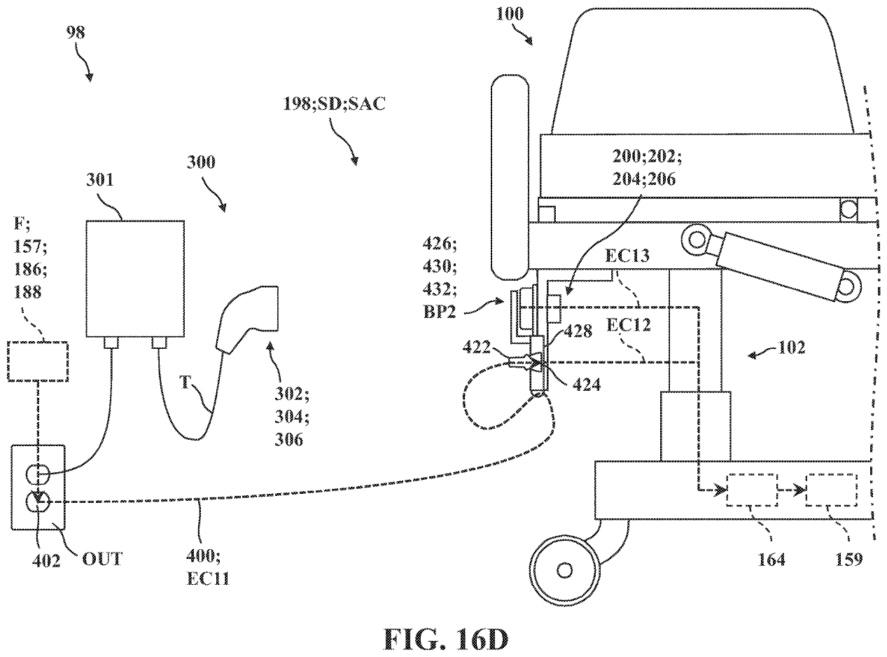

In a fourth instance of the charging connection system 198, which is shown in FIGS. 16A-16D, the auxiliary charging cable 400 extends in electrical communication EC11 between the plug 402 and a shielded plug 422. As shown, the auxiliary charging cable 400 may be operatively attached to the support structure 102 between the plug 402 and the shielded plug 422. Additionally, the charging connection system 198 further includes a socket 424 disposed in electrical communication EC12 with the charger 164 and shaped to receive the shielded plug 422. Furthermore, the apparatus interface 200 is disposed in electrical communication EC13 with the charger 164.

The shielded plug 422 may be any suitable plug, and the socket 424 may be any suitable corresponding socket for receiving the shielded plug 422. For example, the shielded plug 422 may be any one of a type A, B, C, D, E, F, F/G, G, H, I, J, K, L, M, or N plug and the socket 424 may be any one of a corresponding type A, B, C, D, E, F, F/G, G, H, I, J, K, L, M, or N socket. In a more specific example, the shielded plug 422 may be an IEC plug and the socket 424 may be an IEC socket.

Referring to FIG. 16C, the apparatus connector 202 receives the interface connector 302 in the tether state ST. Once the apparatus connector 202 receives the interface connector 302, an electrical connection EC14, EC13 is formed between the facility power system F and the battery 159, and the charging connection system 198 operates in the tether state ST and in the connected state SC.

Referring to FIG. 16D, the socket 424 receives the shielded plug 422 in the auxiliary cable state SAC. In the auxiliary cable state SAC, the electrical connection EC11, EC12 is formed between the facility power system F and the battery 159, and the charging connection system 198 operates in the auxiliary cable state SAC and in the connected state SC. In the instance of FIGS. 16A-16D, removal of the interface connector 302 from the apparatus connector 202 changes operation of the charging connection system 198 out of the tether state ST. Additionally, removal of the shielded plug 422 from the socket 424 changes operation of the charging connection system 198 out of the auxiliary cable state SAC. For example, in FIG. 16A, the interface connector 302 is removed from the apparatus connector 202, and the shielded plug 422 is removed from the socket 424. As follows, the charging connection system 198 in FIG. 13A is not operating in either the tether state ST or the auxiliary cable state SAC and operates in the disconnected state SD.

The instance of the charging connection system 198 of FIGS. 16A-16D includes selector 426 operatively attached to the support structure 102 for ensuring that the charging connection system 198 operates in only one of the tether state TS and the auxiliary cable state SAC at a time. The selector 426 includes a mount 428 supporting the socket 424 and a guide 430 supporting the apparatus connector 202. The guide 430 moves between a first blocking position BP1 shown in FIG. 16A and a second blocking position BP2 shown in FIG. 16B. As shown in FIG. 16A, when the guide 430 is in the first blocking position BP1, the apparatus connector 202 is arranged to receive the interface connector 302 in the tether state TS with at least a portion of the guide 430 inhibiting access to the socket 424 to interrupt electrical communication between the charging connection system 198 and the plug 402 of the auxiliary charging cable 400. In FIG. 16C, the apparatus connector 202 receives the interface connector 302 in the tether state ST while the guide 430 is in the first blocking position BP1. In FIG. 16B, when the guide 430 is in the second blocking position BP2, the socket 424 is arranged to receive the shielded plug 422 in the auxiliary cable state SAC with at least a portion of the guide 430 inhibiting access to the apparatus connector 202 to interrupt electrical communication between the charging connection system 198 and interface connector 302. In FIG. 16D, the socket 424 receives the shielded plug 422 in the auxiliary cable state SAC while the guide 430 is in the second blocking position BP2.

The selector 426 may include any suitable structure for ensuring that the charging connection system 198 operates in only one of the tether state TS and the auxiliary cable state SAC. For example, in some instances, the selector 426 may further include an over-center mechanism 432. The over-center mechanism 432 may be interposed between the mount 428 and the guide 430 to urge the guide 430 into a selected one of the first blocking position BP1 and the second blocking position BP2 in response to a user-applied force. In such instances, a user-applied force acting on the guide 430 moves the over-center mechanism 432 between the selected one of the first blocking position BP1 and the second blocking position BP2 and changes operation of the charging connection system 198 between the tether state ST and the auxiliary cable state SAC.

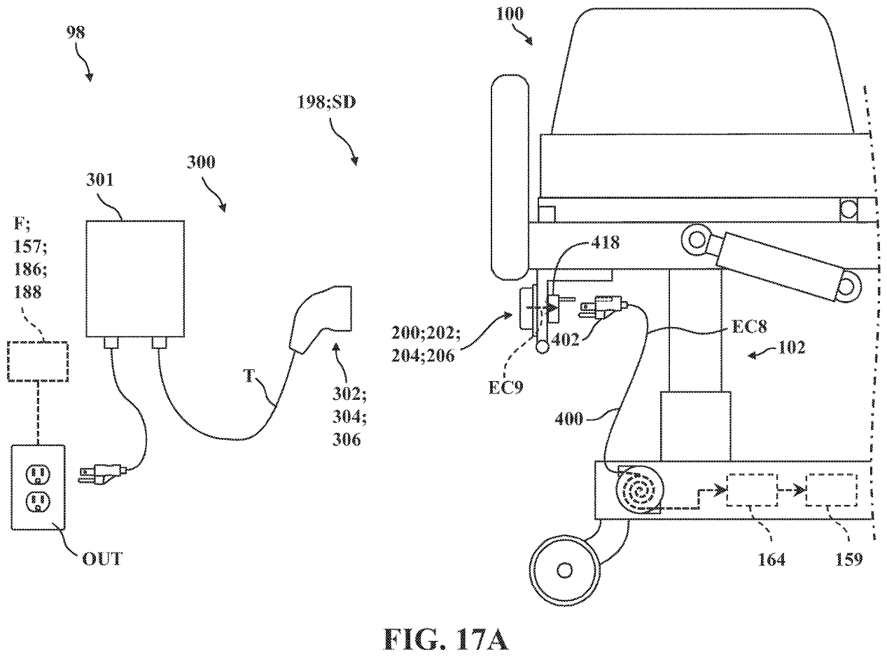

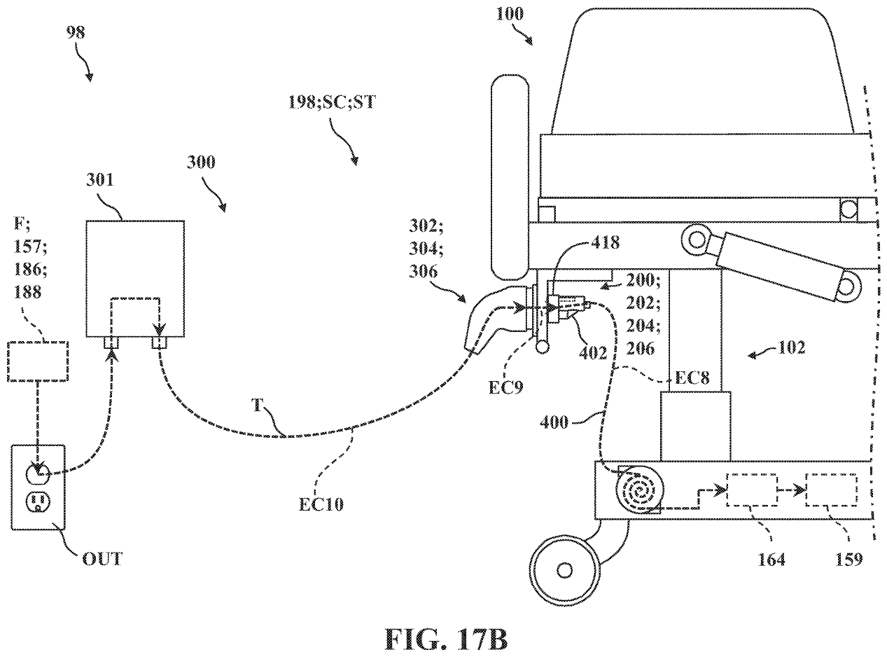

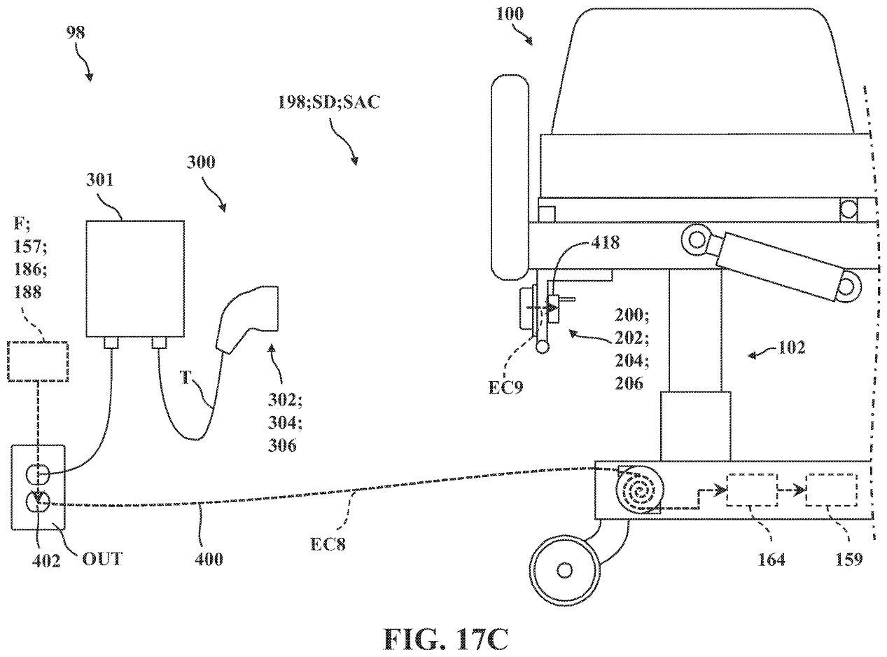

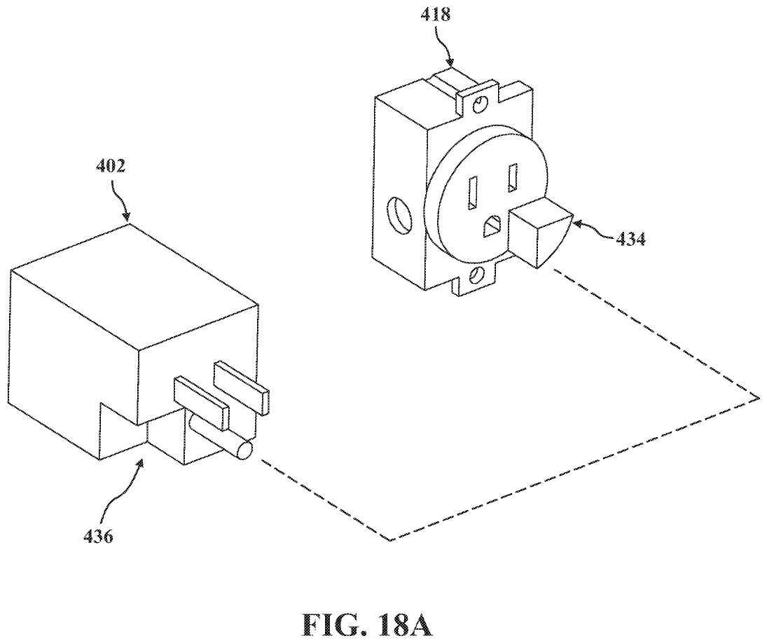

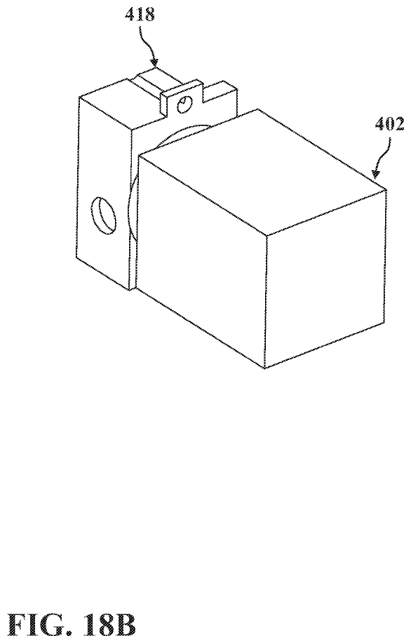

A fifth instance of the charging connection system 198 is shown in FIGS. 17A-17C, which is similar to the third instance of the charging connection system 198 described above in connection with FIGS. 15A-15C. Here in this version, the apparatus socket 418 includes a blocking element 434 which is arranged to inhibit attachment of external devices to the apparatus socket 418, and the plug 402 of the auxiliary charging cable 400 includes a receptacle 436 which is shaped to receive the blocking element 434 of the apparatus socket 418 to facilitate connection of the plug 402 with the apparatus socket 418 in the tether state ST to place the apparatus interface 200 in electrical communication with the charging connection system 198. As is depicted schematically in FIG. 17A (see also FIGS. 18A-18B), the blocking element 434 serves as a “male modifier” to what may in some versions be otherwise configured as a NEMA 5-15 outlet, and the receptacle 436 serves as a “female modifier” to what may in some versions be otherwise configured as a NEMA 5-15 plug. Thus, external devices configured with standard NEMA 5-15 plugs (e.g., infusion pumps, heart monitors, and the like) cannot be connected to the apparatus socket 418 in this version due to the presence of the blocking element 434. However, this configuration does permit the plug 402 to be connected to standard NEMA 5-15 outlets, such as one of the outlets OUT of the facility power system F when needed (see FIG. 17C).

As will be appreciated from the subsequent description below, various types, styles, and configurations of blocking elements 434 and/or receptacles 436 are contemplated by the present disclosure. In the version depicted in FIG. 18A, the blocking element 434 extends outwardly from a face of the apparatus socket 418 adjacent to terminals so as to prevent a standard NEMA 5-15 plug from being connected to the apparatus socket, and the receptacle 436 is defined in the plug 402 as a relief arranged to receive the blocking element 434 (see FIG. 18B; not shown in detail).

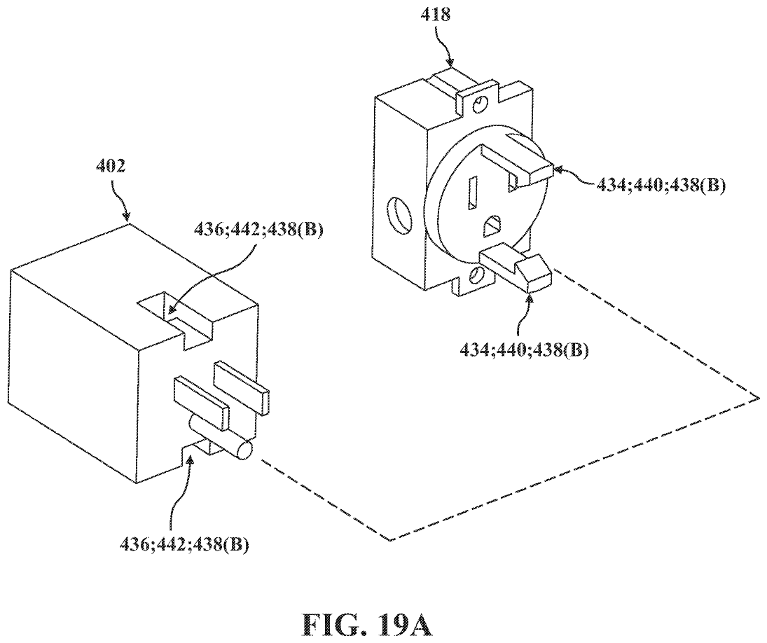

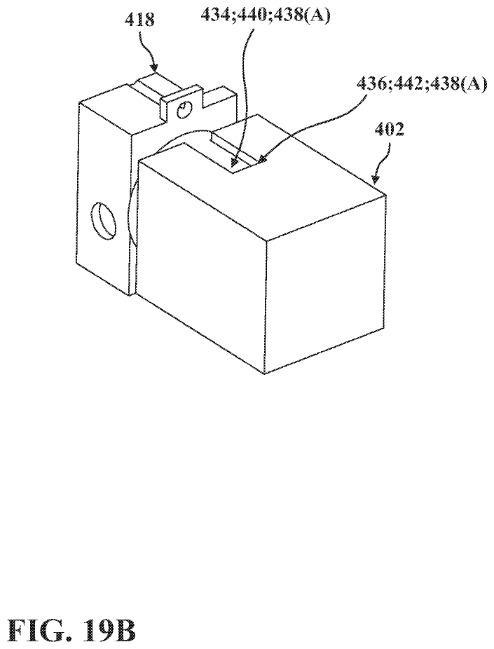

Referring now to FIGS. 19A-19B, in some versions, a retainer 438 is interposed between the apparatus socket 418 and the plug 402 and is operable between a retained state 438A (see FIG. 19B) to maintain connection of the plug 402 with the apparatus socket 418 in the tether state ST, and a released state 438B (see FIG. 19A) to permit disconnection of the plug 402 from the apparatus socket 418. To this end, in some versions, one or more blocking elements 434 and one or more receptacles 436 may define the retainer 438. However, in some versions, the retainer 438 may be configured differently, such as being separate or otherwise spaced from the blocking element 434 and/or receptacle 436. Moreover, in some versions, the retainer 438 may be employed without the blocking element 434 and/or receptacle 436. In the representative version depicted in FIGS. 19A-19B, a pair of blocking elements 434 and a corresponding pair of receptacles 436 are employed and serve as the retainer 438. More specifically, the retainer 438 includes a resilient finger 440 operatively attached to each of the blocking elements 434, and a catch 442 defined adjacent to each of the receptacles 436 and arranged to receive the corresponding resilient fingers 440 in the retained state 438A (see FIG. 19B). As noted above, various configurations are contemplated, and it will be appreciated that a single resilient finger 440 and catch 442 may be employed in some versions.

It will be appreciated that the versions of the retainer 438 described herein help to ensure that the plug 402 remains connected to the apparatus socket 418 and does not inadvertently disconnect during, for example, motion of the patient support apparatus 100. Because a user is required to change out of the retained state 438A to disconnect the plug 402 from the apparatus socket 418, unintended disconnection from vibration, abuse, and the like is inhibited.

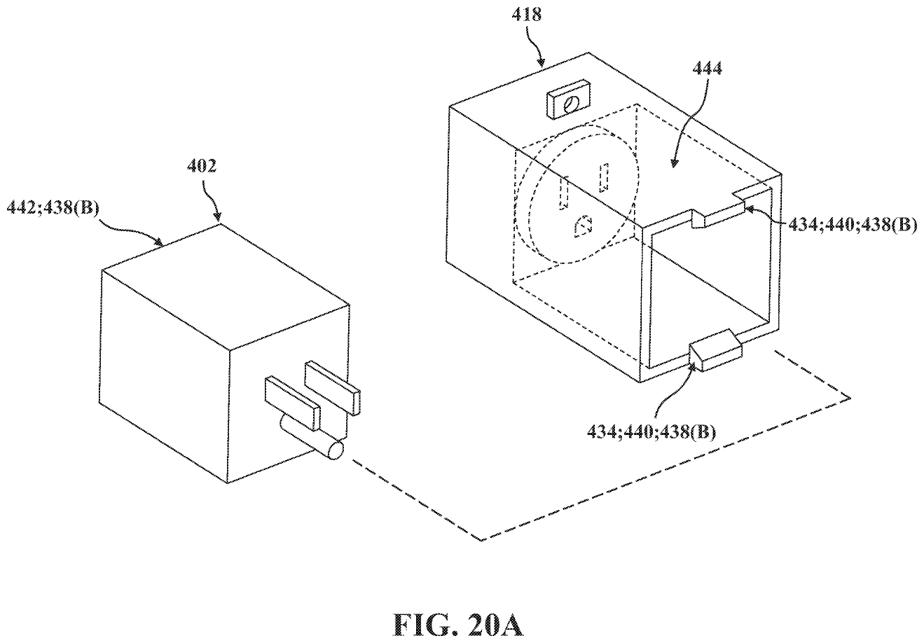

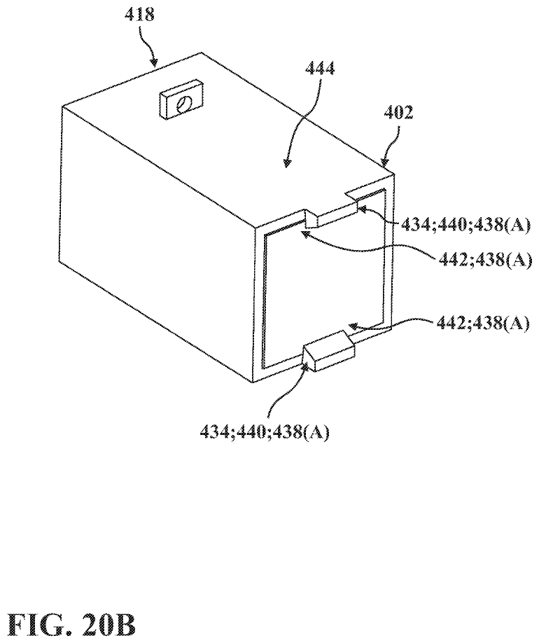

Referring now to FIGS. 20A-20B, in some versions, the retainer 438 or another portion of the plug 402 and/or the apparatus socket 418 may include a shield 444 arranged to at least partially inhibit external contaminants from moving towards one or more of the apparatus socket 418 and the plug 402 in the retained state 438A or in other states. In the illustrated version, the resilient fingers 440 extend from a generally hollow blocking element 434 which is provided with a generally rectangular, tube-shaped profile. Here, the catches 442 are defined by a back face of the plug 402, which is inserted into the tube-shaped profile of the blocking element 434 in the retained state 438A. This configuration helps to shroud the connection from exposure to fluids and other contaminants that could cause damage to the connection. It will be appreciated that the shield 444 could be configured in a number of different ways, including as a component separate from the retainer 438 in some versions. Other configurations are contemplated.

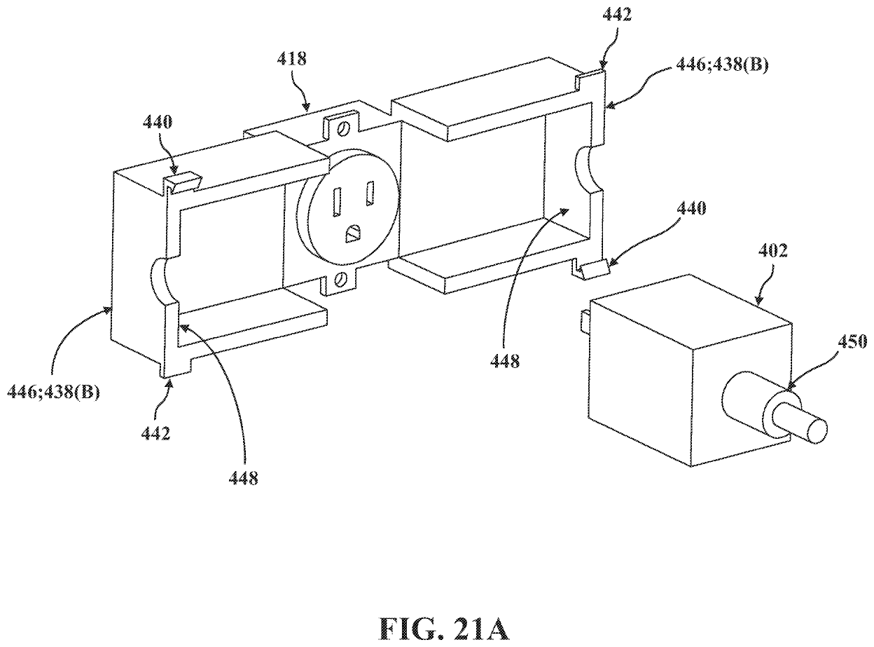

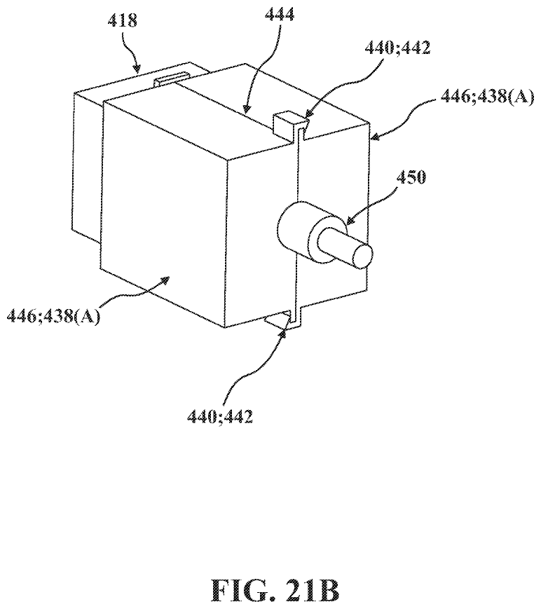

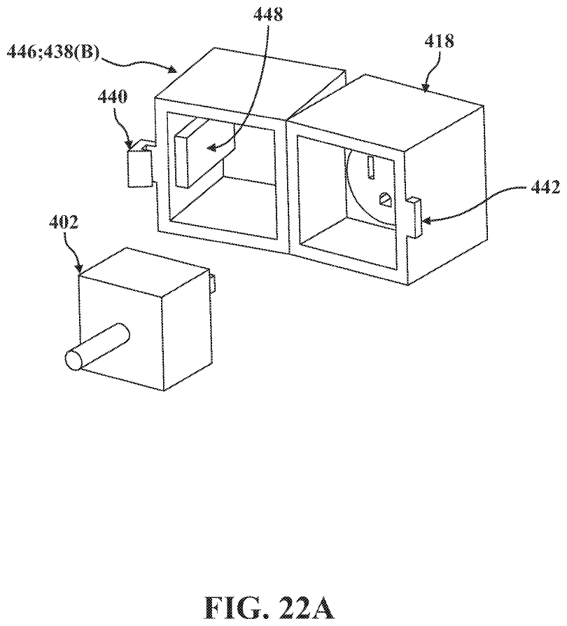

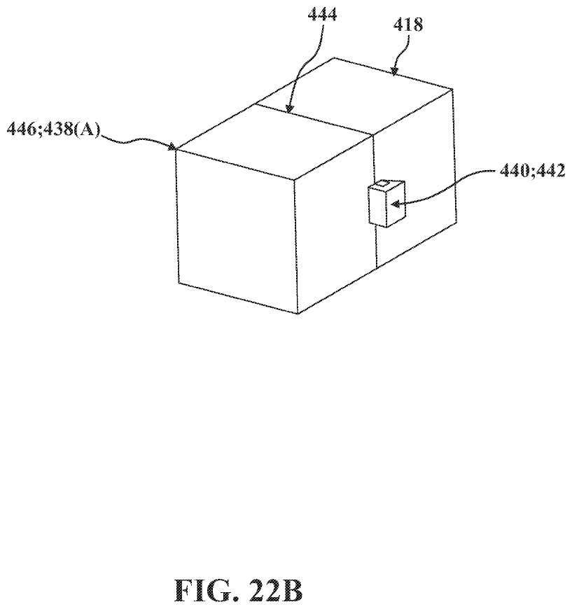

Referring now to FIGS. 21A-22B, in some versions, the retainer 438 may include one or more arms 446 operatively attached to the apparatus socket 418 and arranged to at least partially abut the plug 402 in the retained state 438A. While not depicted throughout the drawings, in some versions one or more arms could be operatively attached to the plug 402 and configured to at least partially abut the apparatus socket 418 in the retained state 438A to maintain operation in the retained state 438A. Other configurations are contemplated. In the version depicted in FIGS. 21A-21B, a pair of “clamshell” arms 446 are employed and are pivotably coupled to the apparatus socket 418, such as via living hinges or other types of pivoting couplings, and are shaped and arranged to surround and enclose the plug 402 in the retained state 438A. The “clamshell” arms 446 may include or otherwise define arm braces 448 to abut portions of the plug 402 to maintain the connection with the apparatus socket 418. In this version, the retained state 438A is maintained by an arrangement of resilient fingers 440 and catches 442 (which do not serve as blocking elements 434 in this version). The “clamshell” arms 446 also serve as a shield 444 in the retained state 438A. In some versions, a gasket 450 may be provided interposed between the plug 402 and the one or more arms 446, and/or other portions of the plug 402 and/or apparatus socket 418, to help facilitate operation of the shield 444 in the retained state 438A. It will be appreciated that various styles, types, and arrangements of gaskets are contemplated.

In the version of the retainer 438 depicted in FIGS. 22A-22B, a single arm 446 is employed, and is pivotably coupled to the apparatus socket 418 so as to define a “box” in which the plug 402 is disposed, with the arm brace 448 abutting the plug 402 to maintain the connection in the retained state 438A. Here, it will be appreciated that the “box” likewise serves as a shield 444.

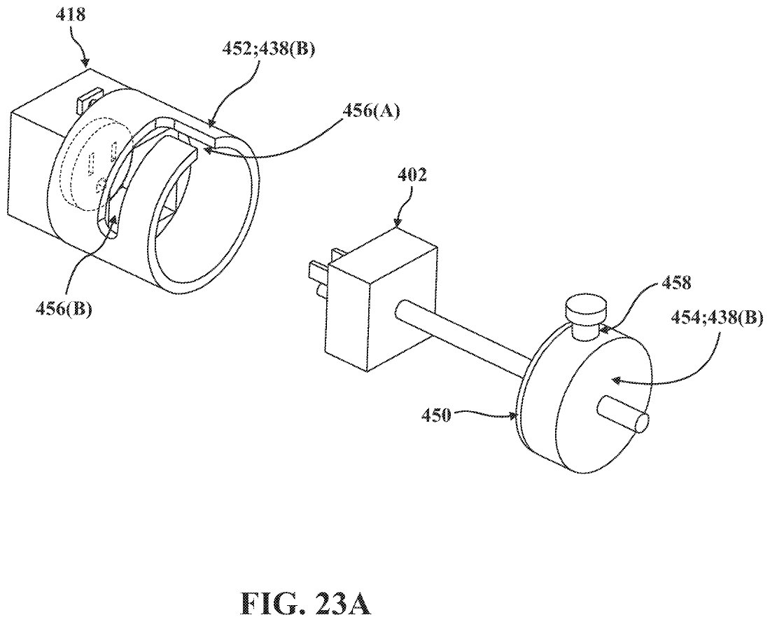

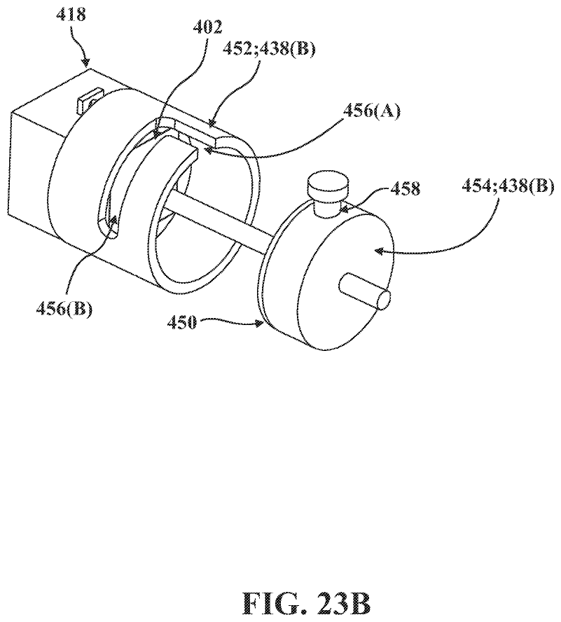

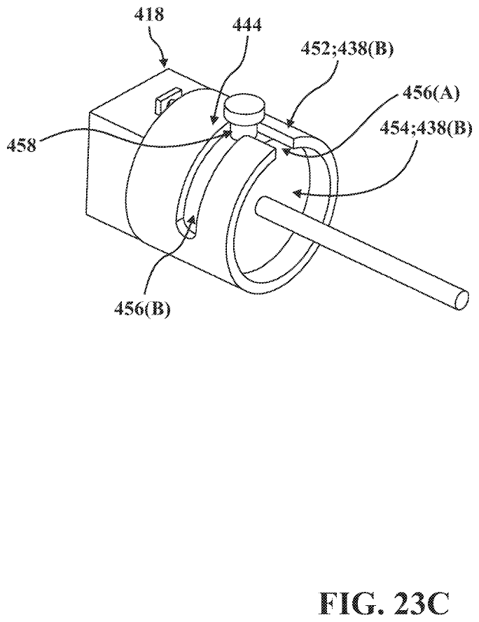

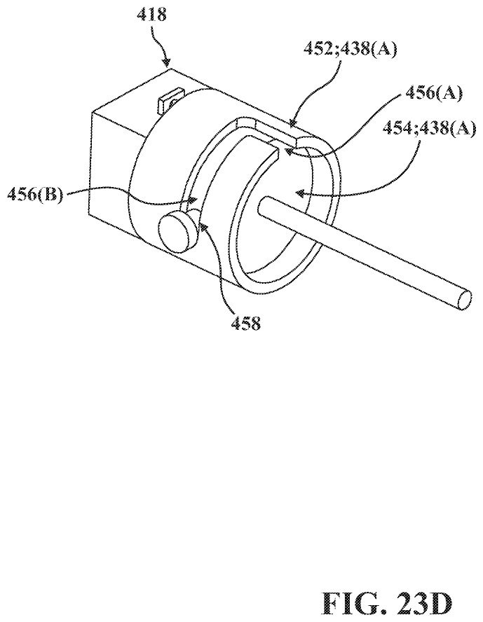

Referring now FIGS. 23A-23D, in this version the retainer 438 includes a bolt catch 452 operatively attached to the apparatus socket 418. The apparatus socket 418 is shaped and arranged to receive the plug 402 (see FIG. 23A), and the bolt catch 452 extends from the apparatus socket 418 to receive a bolt latch 454. The bolt catch 452 defines a catch slot 456 which includes a first catch slot region 456A extending in a linear direction following insertion of the bolt latch 454 into the bolt catch 452, and a second catch slot region 456B extending in a radial direction. The bolt latch 454 may include a gasket 450 in some versions. Here, the bolt latch 454 is movable along the wire coupled to the plug 402 and includes a pin 458 shaped to pass into the first catch slot region 456A as the bolt latch 454 is inserted linearly into the bolt catch 452 (compare FIGS. 23A-23C). From this point, the bolt latch 454 can be rotated to position the pin 458 in the second catch slot region 456B to secure the bolt latch 454 to the bolt catch 452 and maintain the retainer 438 in the retained state 438A (compare FIGS. 23C-23D).

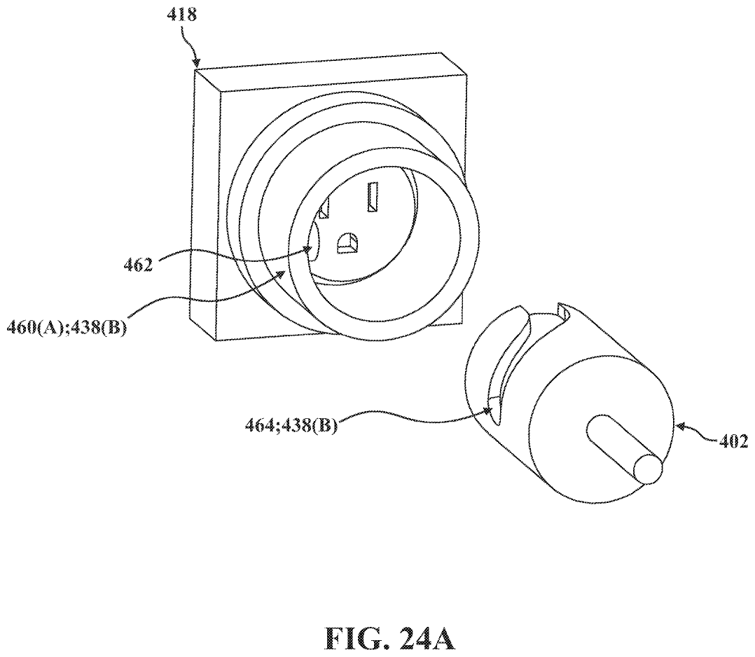

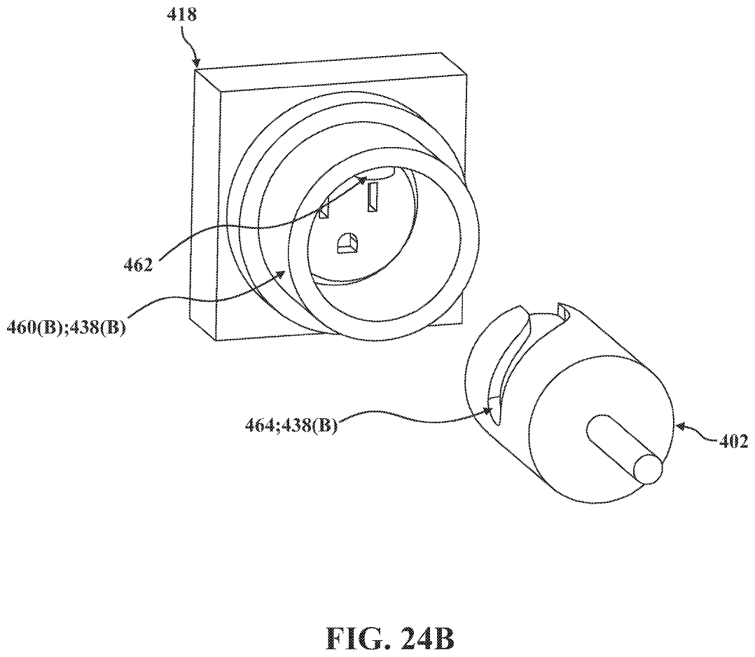

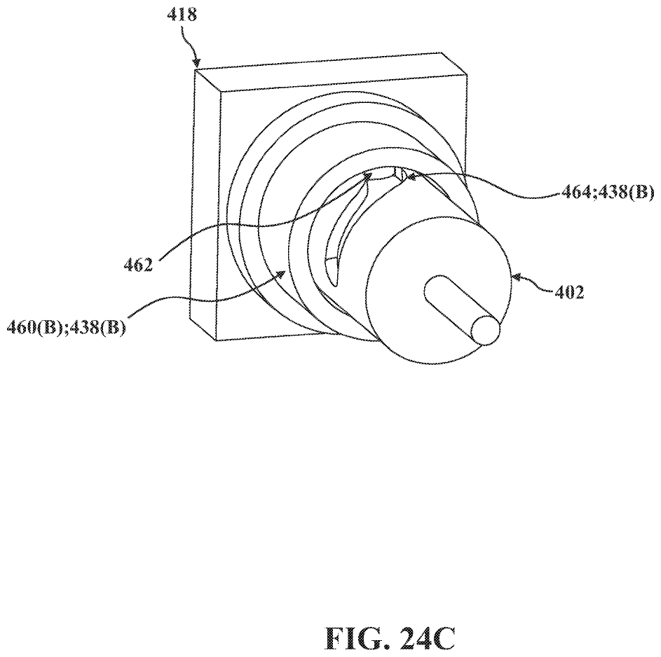

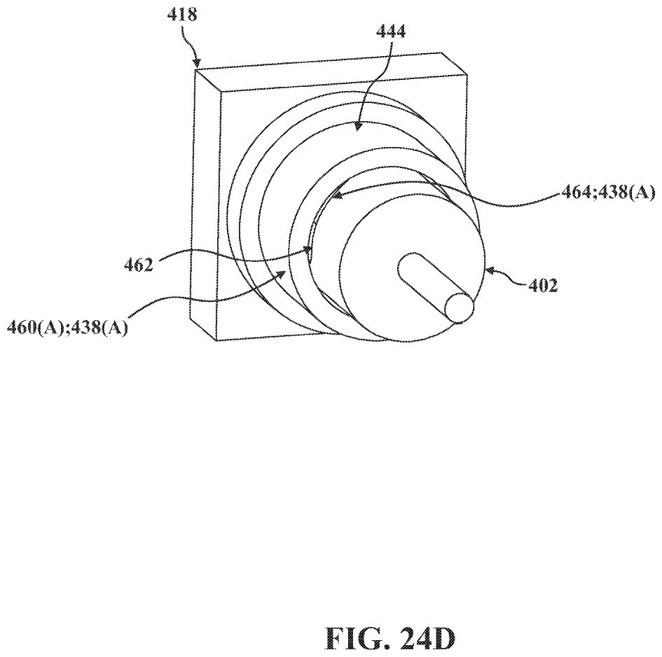

Referring now to FIGS. 24A-24D, in this version the retainer 438 includes a lock ring 460 operatively attached to the apparatus socket 418 and supporting a ring key 462. The lock ring 460 is arranged for rotation relative to the apparatus socket 418 between a first ring position 460A and a second ring position 460B. A curved slot 464 defined in the plug 402 is shaped to receive the ring key 462 in the second ring position 460B (see FIGS. 24B-24C), and to retain the ring key 462 as the lock ring 460 moves to the first ring position 460A (see FIG. 24D) to maintain operation of the retainer 438 in the retained state 438A. In some versions, the lock ring 460 may be biased towards the first ring position 460A (see FIGS. 24A and 24D), such as with a torsion spring (not shown), whereby a user could rotate the lock ring 460 from the first ring position 460A (see FIG. 24A) to the second ring position 460B (see FIG. 24B) to allow connection of the plug 402. Other configurations are contemplated.

Several implementations have been discussed in the foregoing description. However, the implementations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

The present disclosure also comprises the following clauses, with specific features laid out in dependent clauses, that may specifically be implemented as described in greater detail with reference to the configurations and drawings above.

### CLAUSES

I. A system for providing power to a patient support apparatus, the system comprising:
   a facility power system for providing a source of alternating current power to a plurality of outlets;
   a facility interface disposed in electrical communication with the source of alternating current power and including:
      a facility module coupled to the source of alternating current power,
      an interface connector supporting an interface magnetic element and an interface terminal, and
      a tether extending between the facility module and the interface connector to electrically couple the interface terminal with the source of alternating current power; and
   a patient support apparatus including:
      a support structure with a patient support deck,
      a battery operatively attached to the support structure,
      a powered device to perform a powered function of the patient support apparatus, and
      a charging connection system including:
         a charger disposed in electrical communication with the battery;
         an apparatus interface disposed in electrical communication with the charger and including an apparatus connector shaped to receive the interface connector and supporting an apparatus magnetic element and an apparatus terminal; and
         an auxiliary charging cable extending to a plug configured to releasably couple to one of the plurality of outlets;
      wherein the charging connection system is selectively operable between:
         a tether state where the interface connector is disposed in electrical communication with the charging connection system, and
         an auxiliary cable state where the plug of the auxiliary charging cable is disposed in electrical communication with the charging connection system and where electrical communication is interrupted between the charging connection system and the interface connector.
II. The system of clause I, wherein the apparatus connector is configured to releasably couple to the interface connector with the apparatus terminal abutting the interface terminal in response to magnetic attraction occurring between the apparatus magnetic element and the interface magnetic element to facilitate charging of the battery with the source of alternating current power during operation of the charging connection system in the tether state.
III. The system of any of clauses I-II, wherein the auxiliary charging cable extends in electrical communication between the plug and a shielded plug;
   wherein the apparatus interface further includes an apparatus plug disposed in electrical communication with the apparatus connector; and
   wherein the charging connection system further includes a socket disposed in electrical communication with the charger and shaped to receive the apparatus plug in the tether state to place the apparatus interface in electrical communication with the charging connection system, and to receive the shielded plug in the auxiliary cable state to place the auxiliary charging cable in electrical communication with the charging connection system.
IV. The system of clause III, wherein removal of the apparatus plug from the socket changes operation of the charging connection system out of the tether state; and
   wherein removal of the shielded plug from the socket changes operation of the charging connection system out of the auxiliary cable state.
V. The system of any of clauses III-IV wherein the apparatus connector is operatively attached to the support structure; and
   wherein the socket is movable relative to the apparatus connector to change operation of the charging connection system between the tether state and the auxiliary cable state.
VI. The system of any of clauses III-V, wherein the auxiliary charging cable is operatively attached to the support structure between the plug and the shielded plug.
VII. The system of any of clauses I-VI, wherein the auxiliary charging cable extends in electrical communication between the plug and an auxiliary interface having an auxiliary connector supporting an auxiliary magnetic element and an auxiliary terminal; and
   wherein the apparatus connector is shaped to receive the auxiliary connector in the auxiliary cable state to place the auxiliary charging cable in electrical communication with the charging connection system.
VIII. The system of clause VII, wherein removal of the interface connector from the apparatus connector changes operation of the charging connection system out of the tether state; and
   wherein removal of the auxiliary connector from the apparatus connector changes operation of the charging connection system out of the auxiliary cable state.
IX. The system of any of clauses VII-VIII, wherein the auxiliary charging cable is operatively attached to the support structure between the plug and the auxiliary connector; and
   wherein the auxiliary connector is movable relative to the apparatus connector to change operation of the charging connection system between the tether state and the auxiliary cable state.
X. The system of any of clauses VII-IX, wherein the apparatus connector is configured to releasably couple to the interface connector with the apparatus terminal abutting the interface terminal in response to magnetic attraction occurring between the apparatus magnetic element and the interface magnetic element to facilitate charging of the battery with the source of alternating current power during operation of the charging connection system in the tether state; and
   wherein the apparatus connector is configured to releasably couple to the auxiliary connector with the apparatus terminal abutting the auxiliary terminal in response to magnetic attraction occurring between the apparatus magnetic element and the auxiliary magnetic element to facilitate charging of the battery with the source of alternating current power during operation of the charging connection system in the auxiliary cable state.
XI. The system of any of clauses I-X, wherein the auxiliary charging cable extends in electrical communication between the plug and the charger;
   wherein the apparatus interface further includes an apparatus socket disposed in electrical communication with the apparatus connector and shaped to receive the plug of the auxiliary charging cable in the tether state to place the apparatus interface in electrical communication with the charging connection system.
XII. The system of clause XI, wherein removal of the plug from the apparatus socket changes operation of the charging connection system out of the tether state.
XIII. The system of any of clauses XI-XII, wherein the apparatus connector is operatively attached to the support structure; and
   wherein the plug is movable relative to the apparatus connector to change operation of the charging connection system between the tether state and the auxiliary cable state.
XIV. The system of clause XIII, further including a cable retractor operatively attached to the support structure, the cable retractor supporting the auxiliary charging cable to permit movement of the plug between the apparatus socket and the plurality of outlets of the facility power system.
XV. The system of any of clauses XI-XIV, wherein the apparatus socket includes a blocking element arranged to inhibit attachment of external devices to the apparatus socket.
XVI. The system of clause XV, wherein the plug of the auxiliary charging cable includes a receptacle shaped to receive the blocking element of the apparatus socket to facilitate connection of the plug with the apparatus socket in the tether state to place the apparatus interface in electrical communication with the charging connection system.
XVII. The system of clause XVI, wherein the blocking element and the receptacle define a retainer operable between:
   a retained state to maintain connection of the plug with the apparatus socket in the tether state, and
   a released state to permit disconnection of the plug from the apparatus socket.
XVIII. The system of clause XVII, wherein the retainer includes a resilient finger operatively attached to the blocking element, and a catch defined adjacent to the receptacle and arranged to receive the resilient finger in the retained state.
XIX. The system of clause XVIII, wherein the retainer further includes a shield arranged to at least partially inhibit external contaminants from moving towards one or more of the apparatus socket and the plug in the retained state.
XX. The system of any of clauses XI-XIX, further comprising a retainer interposed between the apparatus socket and the plug and being operable between:
   a retained state to maintain connection of the plug with the apparatus socket in the tether state, and
   a released state to permit disconnection of the plug from the apparatus socket.
XXI. The system of clause XX, wherein the retainer includes a shield arranged to at least partially inhibit external contaminants from moving towards one or more of the apparatus socket and the plug in the retained state.
XXII. The system of any of clauses XX-XXI wherein the retainer includes one or more arms operatively attached to the apparatus socket and arranged to at least partially abut the plug in the retained state.
XXIII. The system of clause XXII, wherein the retainer further includes a gasket interposed between the plug and the one or more arms.
XXIV. The system of any of clauses XX-XXIII, wherein the retainer includes a bolt catch operatively attached to the apparatus socket, and a bolt latch shaped to releasably engage the bolt catch in the retained state.
XXV. The system of any of clauses XX-XXIV, wherein the retainer includes:
   a lock ring operatively attached to the apparatus socket and supporting a ring key for rotation relative to the apparatus socket between a first ring position and a second ring position, and
   a curved slot defined in the plug and shaped to receive the ring key in the second ring position and to retain the ring key as the lock ring moves to the first ring position to maintain operation in the retained state.
XXVI. The system of any of clauses I-XXV, wherein the auxiliary charging cable extends in electrical communication between the plug and a shielded plug; and
   wherein the charging connection system further includes a socket disposed in electrical communication with the charger and shaped to receive the shielded plug in the auxiliary cable state to place the auxiliary charging cable in electrical communication with the charging connection system.
XXVII. The system of clause XXVI, wherein the apparatus interface further includes a selector operatively attached to the support structure, the selector including:
   a mount supporting the socket; and
   a guide supporting the apparatus connector for movement relative to the mount between:
      a first blocking position where the apparatus connector is arranged to receive the interface connector in the tether state with at least a portion of the guide inhibiting access to the socket to interrupt electrical communication between the charging connection system and the plug of the auxiliary charging cable, and
      a second blocking position where the socket is arranged to receive the shielded plug in the auxiliary cable state with at least a portion of the guide inhibiting access to the apparatus connector to interrupt electrical communication between the charging connection system and interface connector.
XXVIII. The system of clause XXVII, wherein the selector further includes an over-center mechanism interposed between the mount and the guide to urge the guide into a selected one of the first blocking position and the second blocking position in response to user-applied force.
XXIX. The system of clause XXVIII, wherein user-applied force acting on the guide to move the over-center mechanism between the selected one of the first blocking position and the second blocking position changes operation of the charging connection system between the tether state and the auxiliary cable state.
XXX. The system of any of clauses XXVI-XXIX, wherein the auxiliary charging cable is operatively attached to the support structure between the plug and the shielded plug.
XXXI. The system of any of clauses XXVI-XXX, wherein the apparatus interface is disposed in electrical communication with the charger.
XXXII. A system for providing power to a patient support apparatus, the system comprising:
   a facility power system for providing a source of alternating current power to a plurality of outlets;
   a facility interface disposed in electrical communication with the source of alternating current power and including:
      a facility module coupled to the source of alternating current power,
      an interface connector supporting an interface magnetic element, and
      a tether extending between the facility module and the interface connector to electrically couple with the source of alternating current power; and
   a patient support apparatus including:
      a support structure with a patient support deck,
      a battery operatively attached to the support structure,
      a powered device to perform a powered function of the patient support apparatus,
      a charging connection system including:
         a charger disposed in electrical communication with the battery;
         an apparatus interface disposed in electrical communication with the charger and including an apparatus connector shaped to receive the interface connector and supporting an apparatus magnetic element; and
         an auxiliary charging cable extending to a plug configured to releasably couple to one of the plurality of outlets;
      wherein the charging connection system is selectively operable between:
         a tether state where the interface connector is disposed in electrical communication with the charging connection system via connection to the apparatus connector and where electrical communication is interrupted between the charging connection system and the plug of the auxiliary charging cable, and
         an auxiliary cable state where the plug of the auxiliary charging cable is disposed in electrical communication with the charging connection system and where electrical communication is interrupted between the charging connection system and the apparatus connector.
XXXIII. The system of clause XXXII, wherein the interface connector supports an interface terminal disposed in electrical communication with the source of alternating current power;
   wherein the apparatus connector supports an apparatus terminal; and
   wherein the apparatus connector is configured to releasably couple to the interface connector with the apparatus terminal abutting the interface terminal in response to magnetic attraction occurring between the apparatus magnetic element and the interface magnetic element to facilitate charging of the battery with the source of alternating current power during operation of the charging connection system in the tether state.
XXXIV. The system of any of clauses XXXII-XXXIII, wherein the auxiliary charging cable extends in electrical communication between the plug and a shielded plug;
   wherein the apparatus interface further includes an apparatus plug disposed in electrical communication with the apparatus connector; and
   wherein the charging connection system further includes a socket disposed in electrical communication with the charger and shaped to receive the apparatus plug in the tether state to place the apparatus interface in electrical communication with the charging connection system, and to receive the shielded plug in the auxiliary cable state to place the auxiliary charging cable in electrical communication with the charging connection system.
XXXV. The system of clause XXXIV, wherein removal of the apparatus plug from the socket changes operation of the charging connection system out of the tether state; and
   wherein removal of the shielded plug from the socket changes operation of the charging connection system out of the auxiliary cable state.
XXXVI. The system of any of clauses XXXIV-XXXV, wherein the apparatus connector is operatively attached to the support structure; and
   wherein the socket is movable relative to the apparatus connector to change operation of the charging connection system between the tether state and the auxiliary cable state.
XXXVII. The system of any of clauses XXXIV-XXXVI, wherein the auxiliary charging cable is operatively attached to the support structure between the plug and the shielded plug.
XXXVIII. The system of any of clauses XXXII-XXXVII, wherein the auxiliary charging cable extends in electrical communication between the plug and an auxiliary interface having an auxiliary connector supporting an auxiliary magnetic element and an auxiliary terminal; and
   wherein the apparatus connector is shaped to receive the auxiliary connector in the auxiliary cable state to place the auxiliary charging cable in electrical communication with the charging connection system.
XXXIX. The system of clause XXXVIII, wherein removal of the interface connector from the apparatus connector changes operation of the charging connection system out of the tether state; and
   wherein removal of the auxiliary connector from the apparatus connector changes operation of the charging connection system out of the auxiliary cable state.
XL. The system of any of clauses XXXVIII-XXXIX, wherein the auxiliary charging cable is operatively attached to the support structure between the plug and the auxiliary connector; and
   wherein the auxiliary connector is movable relative to the apparatus connector to change operation of the charging connection system between the tether state and the auxiliary cable state.
XLI. The system of any of clauses XXXVIII-XLI, wherein the interface connector supports an interface terminal disposed in electrical communication with the source of alternating current power;
   wherein the apparatus connector supports an apparatus terminal;
   wherein the apparatus connector is configured to releasably couple to the interface connector with the apparatus terminal abutting the interface terminal in response to magnetic attraction occurring between the apparatus magnetic element and the interface magnetic element to facilitate charging of the battery with the source of alternating current power during operation of the charging connection system in the tether state; and
   wherein the apparatus connector is configured to releasably couple to the auxiliary connector with the apparatus terminal abutting the auxiliary terminal in response to magnetic attraction occurring between the apparatus magnetic element and the auxiliary magnetic element to facilitate charging of the battery with the source of alternating current power during operation of the charging connection system in the auxiliary cable state.
XLII. The system of any of clauses XXXII-XLI wherein the auxiliary charging cable extends in electrical communication between the plug and the charger;
   wherein the apparatus interface further includes an apparatus socket disposed in electrical communication with the apparatus connector and shaped to receive the plug of the auxiliary charging cable in the tether state to place the apparatus interface in electrical communication with the charging connection system.
XLIII. The system of clause XLII, wherein removal of the plug from the apparatus socket changes operation of the charging connection system out of the tether state.
XLIV. The system of any of clauses XLII-XLIII, wherein the apparatus connector is operatively attached to the support structure; and
   wherein the plug is movable relative to the apparatus connector to change operation of the charging connection system between the tether state and the auxiliary cable state.
XLV. The system of clause XLIV, further including a cable retractor operatively attached to the support structure, the cable retractor supporting the auxiliary charging cable to permit movement of the plug between the apparatus socket and the plurality of outlets of the facility power system.
XLVI. The system of any of clauses XLII-XLVI, wherein the apparatus socket includes a blocking element arranged to inhibit attachment of external devices to the apparatus socket.
XLVII. The system of clause XLVI, wherein the plug of the auxiliary charging cable includes a receptacle shaped to receive the blocking element of the apparatus socket to facilitate connection of the plug with the apparatus socket in the tether state to place the apparatus interface in electrical communication with the charging connection system.
XLVIII. The system of clause XLVII, wherein the blocking element and the receptacle define a retainer operable between:
   a retained state to maintain connection of the plug with the apparatus socket in the tether state, and
   a released state to permit disconnection of the plug from the apparatus socket.
XLIX. The system of clause XLVIII, wherein the retainer includes a resilient finger operatively attached to the blocking element, and a catch defined adjacent to the receptacle and arranged to receive the resilient finger in the retained state.
L. The system of clause XLIX, wherein the retainer further includes a shield arranged to at least partially inhibit external contaminants from moving towards one or more of the apparatus socket and the plug in the retained state.
LI. The system of any of clauses XLII-L, further comprising a retainer interposed between the apparatus socket and the plug and being operable between:
   a retained state to maintain connection of the plug with the apparatus socket in the tether state, and
   a released state to permit disconnection of the plug from the apparatus socket.
LII. The system of clause LI, wherein the retainer includes a shield arranged to at least partially inhibit external contaminants from moving towards one or more of the apparatus socket and the plug in the retained state.
LIII. The system of any of clauses LI-LII, wherein the retainer includes one or more arms operatively attached to the apparatus socket and arranged to at least partially abut the plug in the retained state.
LIV. The system of clause LIII, wherein the retainer further includes a gasket interposed between the plug and the one or more arms.
LV. The system of any of clauses LI-LIV, wherein the retainer includes a bolt catch operatively attached to the apparatus socket, and a bolt latch shaped to releasably engage the bolt catch in the retained state.
LVI. The system of any of clauses LI-LV, wherein the retainer includes:
   a lock ring operatively attached to the apparatus socket and supporting a ring key for rotation relative to the apparatus socket between a first ring position and a second ring position, and
   a curved slot defined in the plug and shaped to receive the ring key in the second ring position and to retain the ring key as the lock ring moves to the first ring position to maintain operation in the retained state.
LVII. The system of any of clauses XXXII-LVI, wherein the auxiliary charging cable extends in electrical communication between the plug and a shielded plug; and
   wherein the charging connection system further includes a socket disposed in electrical communication with the charger and shaped to receive the shielded plug in the auxiliary cable state to place the auxiliary charging cable in electrical communication with the charging connection system.
LVIII. The system of clause LVII, wherein the apparatus interface further includes a selector operatively attached to the support structure, the selector including:
   a mount supporting the socket; and
   a guide supporting the apparatus connector for movement relative to the mount between:
      a first blocking position where the apparatus connector is arranged to receive the interface connector in the tether state with at least a portion of the guide inhibiting access to the socket to interrupt electrical communication between the charging connection system and the plug of the auxiliary charging cable, and
      a second blocking position where the socket is arranged to receive the shielded plug in the auxiliary cable state with at least a portion of the guide inhibiting access to the apparatus connector to interrupt electrical communication between the charging connection system and interface connector.
LIX. The system of clause LVIII, wherein the selector further includes an over-center mechanism interposed between the mount and the guide to urge the guide into a selected one of the first blocking position and the second blocking position in response to user-applied force.
LX. The system of clause LIX, wherein user-applied force acting on the guide to move the over-center mechanism between the selected one of the first blocking position and the second blocking position changes operation of the charging connection system between the tether state and the auxiliary cable state.
LXI. The system of any of clauses LVII-LX, wherein the auxiliary charging cable is operatively attached to the support structure between the plug and the shielded plug.
LXII. The system of any of clauses LVII-LXI, wherein the apparatus interface is disposed in electrical communication with the charger.

1. A system for providing power to a patient support apparatus, the system comprising:
a facility power system for providing a source of alternating current power to a plurality of outlets;
a facility interface disposed in electrical communication with the source of alternating current power and including:
a facility module coupled to the source of alternating current power,
an interface connector supporting an interface magnetic element and an interface terminal, and
a tether extending between the facility module and the interface connector to electrically couple the interface terminal with the source of alternating current power; and
a patient support apparatus including:
a support structure with a patient support deck,
a battery operatively attached to the support structure,
a powered device to perform a powered function of the patient support apparatus, and
a charging connection system including:
a charger disposed in electrical communication with the battery;
an apparatus interface disposed in electrical communication with the charger and including an apparatus connector shaped to receive the interface connector and supporting an apparatus magnetic element and an apparatus terminal; and
an auxiliary charging cable extending to a plug configured to releasably couple to one of the plurality of outlets;
wherein the charging connection system is selectively operable between:
a tether state where the interface connector is disposed in electrical communication with the charging connection system, and
an auxiliary cable state where the plug of the auxiliary charging cable is disposed in electrical communication with the charging connection system and where electrical communication is interrupted between the charging connection system and the interface connector.

2. The system of claim 1, wherein the apparatus connector is configured to releasably couple to the interface connector with the apparatus terminal abutting the interface terminal in response to magnetic attraction occurring between the apparatus magnetic element and the interface magnetic element to facilitate charging of the battery with the source of alternating current power during operation of the charging connection system in the tether state.

3. The system of claim 1, wherein the auxiliary charging cable extends in electrical communication between the plug and a shielded plug;
wherein the apparatus interface further includes an apparatus plug disposed in electrical communication with the apparatus connector; and
wherein the charging connection system further includes a socket disposed in electrical communication with the charger and shaped to receive the apparatus plug in the tether state to place the apparatus interface in electrical communication with the charging connection system, and to receive the shielded plug in the auxiliary cable state to place the auxiliary charging cable in electrical communication with the charging connection system.

4. The system of claim 3, wherein removal of the apparatus plug from the socket changes operation of the charging connection system out of the tether state; and
wherein removal of the shielded plug from the socket changes operation of the charging connection system out of the auxiliary cable state.

5. The system of claim 3, wherein the apparatus connector is operatively attached to the support structure; and
wherein the socket is movable relative to the apparatus connector to change operation of the charging connection system between the tether state and the auxiliary cable state.

6. The system of claim 3, wherein the auxiliary charging cable is operatively attached to the support structure between the plug and the shielded plug.

7. The system of claim 1, wherein the auxiliary charging cable extends in electrical communication between the plug and an auxiliary interface having an auxiliary connector supporting an auxiliary magnetic element and an auxiliary terminal; and
wherein the apparatus connector is shaped to receive the auxiliary connector in the auxiliary cable state to place the auxiliary charging cable in electrical communication with the charging connection system.

8. The system of claim 7, wherein removal of the interface connector from the apparatus connector changes operation of the charging connection system out of the tether state; and
wherein removal of the auxiliary connector from the apparatus connector changes operation of the charging connection system out of the auxiliary cable state.

9. The system of claim 7, wherein the auxiliary charging cable is operatively attached to the support structure between the plug and the auxiliary connector; and
wherein the auxiliary connector is movable relative to the apparatus connector to change operation of the charging connection system between the tether state and the auxiliary cable state.

10. The system of claim 7, wherein the apparatus connector is configured to releasably couple to the interface connector with the apparatus terminal abutting the interface terminal in response to magnetic attraction occurring between the apparatus magnetic element and the interface magnetic element to facilitate charging of the battery with the source of alternating current power during operation of the charging connection system in the tether state; and
wherein the apparatus connector is configured to releasably couple to the auxiliary connector with the apparatus terminal abutting the auxiliary terminal in response to magnetic attraction occurring between the apparatus magnetic element and the auxiliary magnetic element to facilitate charging of the battery with the source of alternating current power during operation of the charging connection system in the auxiliary cable state.

11. The system of claim 1, wherein the auxiliary charging cable extends in electrical communication between the plug and the charger;
wherein the apparatus interface further includes an apparatus socket disposed in electrical communication with the apparatus connector and shaped to receive the plug of the auxiliary charging cable in the tether state to place the apparatus interface in electrical communication with the charging connection system.

12. The system of claim 11, wherein removal of the plug from the apparatus socket changes operation of the charging connection system out of the tether state.

13. The system of claim 11, wherein the apparatus connector is operatively attached to the support structure;
wherein the plug is movable relative to the apparatus connector to change operation of the charging connection system between the tether state and the auxiliary cable state; and
further including a cable retractor operatively attached to the support structure, the cable retractor supporting the auxiliary charging cable to permit movement of the plug between the apparatus socket and the plurality of outlets of the facility power system.

14. (canceled)

15. The system of claim 11, wherein the apparatus socket includes a blocking element arranged to inhibit attachment of external devices to the apparatus socket;
wherein the plug of the auxiliary charging cable includes a receptacle shaped to receive the blocking element of the apparatus socket to facilitate connection of the plug with the apparatus socket in the tether state to place the apparatus interface in electrical communication with the charging connection system;
wherein the blocking element and the receptacle define a retainer operable between:
a retained state to maintain connection of the plug with the apparatus socket in the tether state, and
a released state to permit disconnection of the plug from the apparatus socket;
wherein the retainer includes a resilient finger operatively attached to the blocking element, and a catch defined adjacent to the receptacle and arranged to receive the resilient finger in the retained state; and
wherein the retainer further includes a shield arranged to at least partially inhibit external contaminants from moving towards one or more of the apparatus socket and the plug in the retained state.

16. (canceled)

17. (canceled)

18. (canceled)

19. (canceled)

20. The system of claim 11, further comprising a retainer interposed between the apparatus socket and the plug and being operable between:
a retained state to maintain connection of the plug with the apparatus socket in the tether state, and
a released state to permit disconnection of the plug from the apparatus socket.

21. The system of claim 20, wherein the retainer includes a shield arranged to at least partially inhibit external contaminants from moving towards one or more of the apparatus socket and the plug in the retained state.

22. The system of claim 20, wherein the retainer includes one or more arms operatively attached to the apparatus socket and arranged to at least partially abut the plug in the retained state; and
wherein the retainer further includes a gasket interposed between the plug and the one or more arms.

23. (canceled)

24. The system of claim 20, wherein the retainer includes a bolt catch operatively attached to the apparatus socket, and a bolt latch shaped to releasably engage the bolt catch in the retained state.

25. The system of claim 20, wherein the retainer includes:
a lock ring operatively attached to the apparatus socket and supporting a ring key for rotation relative to the apparatus socket between a first ring position and a second ring position, and
a curved slot defined in the plug and shaped to receive the ring key in the second ring position and to retain the ring key as the lock ring moves to the first ring position to maintain operation in the retained state.

26. The system of claim 1, wherein the auxiliary charging cable extends in electrical communication between the plug and a shielded plug;
wherein the charging connection system further includes a socket disposed in electrical communication with the charger and shaped to receive the shielded plug in the auxiliary cable state to place the auxiliary charging cable in electrical communication with the charging connection system; and
wherein the apparatus interface further includes a selector operatively attached to the support structure, the selector including:
a mount supporting the socket; and
a guide supporting the apparatus connector for movement relative to the mount between:
a first blocking position where the apparatus connector is arranged to receive the interface connector in the tether state with at least a portion of the guide inhibiting access to the socket to interrupt electrical communication between the charging connection system and the plug of the auxiliary charging cable, and
a second blocking position where the socket is arranged to receive the shielded plug in the auxiliary cable state with at least a portion of the guide inhibiting access to the apparatus connector to interrupt electrical communication between the charging connection system and interface connector; and
an over-center mechanism interposed between the mount and the guide to urge the guide into a selected one of the first blocking position and the second blocking position in response to user-applied force, wherein user-applied force acting on the guide to move the over-center mechanism between the selected one of the first blocking position and the second blocking position changes operation of the charging connection system between the tether state and the auxiliary cable state.

27.-62. (canceled)
